(19) United States
(12) Patent Application Publication
(10) Pub. No.: US 2008/0008204 A1
(43) Pub. Date: Jan. 10, 2008

(54) Load balanced type switching apparatus and load balanced type switching method

(75) Inventors: Kenshin Yamada, Tokyo (JP); Hideki Nishizaki, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/822,590

(22) Filed: Jul. 9, 2007

(30) Foreign Application Priority Data
Jul. 10, 2006 (JP) 2006-188930

(51) Int. Cl. H04L 12/56; H04L 12/54

(52) U.S. Cl. 370/412; 370/428

(57) ABSTRACT

A load balanced type switching apparatus includes input stages, intermediate stages connected with the input stages in a mesh manner, and output stages connected with the intermediate stages in a mesh manner. One of the input stages includes a destination detecting section configured to detect a destination one of the output stages corresponding to a reception cell; a cell transmitting section having a storage unit and connected with the intermediate stages in the mesh manner, and configured to store the reception cell from the destination detecting section in the storage unit based on the destination output stage of the reception cell; and a transmission cell determining section configured to manage the cells stored in the storage unit for each destination output stage by using a transmission counter for every output stage and for every intermediate stage, and to select a transmittable cell from among the cells stored in the storage unit, such that a number of the cells to be transmitted to each of the intermediate stages falls within a predetermined range for every destination output stage. The cell transmitting section transmits the transmittable cell to one of the intermediate stages based on the management result.

The present invention relates to a switching apparatus, and more particularly relates to a load balanced type switching apparatus that is provided with input stages, intermediate stages and output stages.

### BACKGROUND ART

As a typical configuration in a load balanced type switching apparatus, an input buffer type switching apparatus, an output buffer type switching apparatus and a shared buffer type switching apparatus are known.

FIG. 1 is a block diagram showing the input buffer type switching apparatus. In the input buffer type switching apparatus, a buffer is provided for each input port to store cells of a fixed length in case that destination ports of the fixed length cells received from a plurality of input ports are same. In the configuration, until the fixed length cell located at the head of the buffer for a certain input port is outputted, the second or later fixed length cells in the buffer cannot be outputted. Therefore, when the fixed length cell stored in the head of the buffer competes in the destination output port with a fixed length cell from a different input port, the fixed length cell is waited. In this case, a next fixed length cell cannot be transmitted (HOL Blocking: Head Of Line Blocking) even when the destination port of the next fixed length cell does not compete. Therefore, there is a case that a throughput is reduced.

In order to solve this problem, as shown in FIG. 2, an input buffer type switching apparatus is known in which a buffer is provided for every destination output port as a VOQ (Virtual Output Queue) in each input port. However, a scheduling process of determining from which input port to which output port the fixed length cell should be transferred is required to be performed for all routes (Number of All Input Ports×Number of All Output Ports). Therefore, a calculation amount increases (H/W Scale Increase), and it is not practicable that multiple ports are accommodated.

FIG. 3 is a block diagram showing an output buffer type switching apparatus. In the output buffer type switching apparatus, fixed length cells received by all of the input ports are multiplexed and outputted to each output port as a signal having a rate equal to N times (N: the number of the accommodated ports) of a rate of the input port. In the output port, a buffer is provided to accumulate the fixed length cells for a waiting operation, when the fixed length cells from the plurality of input ports are transmitted at certain timing. In case of this switching apparatus, as an internal process rate of the switching apparatus, a process rate equal to N times (N: the number of the input ports) of the interface rate is required. In this way, if the high port rate and accommodation of multiple ports are considered, the switching apparatus is not practicable.

FIG. 4 is a block diagram showing a shared buffer type switching apparatus. In the shared buffer type switching apparatus, a buffer is provided between input ports and output ports to use commonly to all ports. Fixed length cells received from all of the input ports are multiplexed and written into the buffer as the signal having a rate equal to N times (N: the number of the input ports) of the input port rate, and the fixed length cells are outputted to the output ports at a same rate as the write rate. In case of this switching apparatus, as an internal process rate of the switching apparatus, the process rate equal to N times (N: the number of the input Ports) of the interface rate is required. In this way, it is difficult when the higher port rate and the accommodation of the multiple ports are considered.

There is a switching apparatus in which a scheduler process for all of the input/output ports is eliminated in the input buffer type switching apparatus and the internal process rate in association with the increase in the number of the ports accommodated needs not to be made faster in the output buffer type switching apparatus and the shared buffer type switching apparatus. As such a switching apparatus, a load balanced type switching apparatus is known. It should be noted that in this load balanced type switching apparatus, it is assumed that a switching process is performed in units of the fixed length cells. Also, there would be supposed that a variable length packet is received to the input/output of the load balanced type switching apparatus. However, in that case, the variable length packet is divided into fixed length cells on the reception and the fixed length cells are combined to convert into the original variable length packet, when it is outputted from the load balanced type switching apparatus.

FIG. 5 shows a configuration example of a load balanced type switching apparatus 10. The load balanced type switching apparatus 10 contains L input stages 1 (1-1 to 1-L), M intermediate stages 2 (2-1 to 2-M), N output stages 3 (3-1 to 3-N), a mesh connection section 4 and a mesh connection section 5. The mesh connection section 4 has a function of connecting the L input stages to the M intermediate stages in a mesh manner, and the mesh connection section 5 has a function of connecting the M intermediate stages to the N output stages in a mesh manner. As the mesh connection sections 4 and 5, there may be a unit that actually uses an optical cable to physically attain the mesh connection, or a unit that uses a switch module such as a crossbar switch for switching of a connection destination to logically attain the mesh connection.

The input stage 1 determines the intermediate stage 2 to which a reception cell is transmitted, and transmits the cell through the mesh connection section 4. Similarly, the intermediate stage 2 determines the output stage 3 to which the cell received from the input stage 1 is transmitted, and transmits the cell through the mesh connection section 5.

The input stages 1 uniformly distribute the reception cells to all of the intermediate stages. Thus, when a cell reception rate of the input stages is assumed to be R, the cells may be transmitted from the respective input stages to the M intermediate stages at a rate of R/M. Then, the mesh connection section 4 may establish the mesh connection between each input stage 1 and each intermediate stage 2 at the rate of R/M. Similarly, with regard to the transmission of the cells from the intermediate stage 2 to the output stage 3, the input stage 1 uniformly distributes the cells to the respective intermediate stages 2. Thus, the cells are considered to be received from each intermediate stage 2 to a certain output stage 3 at a same transfer rate. When the output stage 3 transmits cells to an external unit at a rate of R′, the mesh connection section 5 may attain the mesh connection from each intermediate stage to the output stage 3 at the rate of R′/M. In this way, in the load balanced type switching apparatus 10, the transfer rate can be obtained by dividing the rate of the input stage or output stage by the number M of the intermediate stages in the mesh connection between the input stages and the intermediate stages and the mesh connection between the output stages and the intermediate stages.

In this way, in the load balanced type switching apparatus 10, it is sufficient to establish the mesh connection between the input stages 1 and the intermediate stages 2 at the rate of R/M and establish the mesh connection between the intermediate stages 2 and the output stages 3 at the rate of R′/M. However, the connection may be established at the higher rate, in order to improve the property and because of the other reasons.

Also, when the mesh connection section 4 outputs the cells through one line to each intermediate stage 2, the signals from all of the L input stages 1 are collected, so that the transfer rate of R/M×L is required. When the mesh connection section 5 outputs the cells through one line to each output stage 3, the signals from all of the M intermediate stages 2 are collected, so that the transfer rate of R′/M×M=R′ is required.

The input stage number L, the intermediate stage number M and the output stage number N can be set independently from each other. However, the setting of L=M=N is a typical configuration. Also, typically, a rout rate R to each input stage and a route rate R′ to each output stage are same. In such configuration, as shown in FIG. 6, the functions of the input stage, the intermediate stage and the output stage can be included into one line card 6 (6-1, 6-2 and 6-3). A mesh connection section 7 for connecting the line cards in a mesh manner can be physically attained through one mesh connection. It should be noted that the input stage functions, the intermediate stage functions and the output stage functions correspond to the input stage 1, the intermediate stage 2 and the output stage 3 in FIG. 5, respectively. Also, the mesh connection section 7 corresponds to the mesh connection section 4 and the mesh connection section 5 in FIG. 5.

In the load balanced type switching apparatus 10, a delay is generated at each of the input stage 1, the intermediate stage 2 and the output stage 3. At the input stage 1, the delay is generated due to a cell transmission wait in accordance with a distribution algorism when a process of distributing cells to the intermediate stages 2 is performed. The intermediate stage 2 transmits the cells to each output stages 3 at the rate of R′/M. In case that cells received by the load balanced type switching apparatus 10 are distributed unevenly to a certain destination port, namely, in a situation that the cell are received at a rate higher than a transmission rate R′ of the destination port, the cells are accumulated in a buffer at the intermediate stage, and a delay increases. Also, the output stage 3 receives the cells from the respective intermediate stages 2. However, there is a case that a reception order of the cells is not coincident with the order of the cells received firstly by the input stage 1. After performing a reordering process of rearranging the cells received from the intermediate stage 2 into a normal order, the output stage 3 transmits the cells to an external unit. Thus, a delay is generated through the reordering process.

As the load balanced type switching apparatus 10, several methods of distributing the cells received by the input stages 1 are considered. However, here, the distributing methods of two kinds will be described.

An example 1 is a method referred to as Basic. The Basic method is a method of mechanically distributing the cells received by the input stages 1, into the intermediate stages.

FIG. 7 shows an operation example 1 of the load balanced type switching apparatus in the example 1. In order to simplify its description, the number K of the intermediate stages is assumed to be 3. Also, only the transfer operation from the input stage 1-1 to the respective intermediate stages 2 (2-1, 2-2 and 2-3) will be described below. Any process is not especially performed on the cells received by the input stage 1-1, and the cells are transferred in its original state to the mesh connection section 4. The mesh connection section 4 is assumed to periodically repeat the operation of transmitting the cells received from the input stage 1-1 to the intermediate stages 2-1, 2-2 and 2-3 in turn, in each cell time slot. Here, the reception cells 1-7 are received by the input stage 1-1 as an example. The cells of the oblique lines between the cells 3 and 4 and between the cells 6 and 7 indicate a gap (a state that nothing is received) between the reception cells or a blank (NULL) cell. That is, the cells of the oblique lines indicate that any effective cell does not exist. At first, the input stage 1-1 transfers the reception cells 1 to 7 in their original states to the mesh connection section 4. The mesh connection section 4 transmits the reception cell 1 to the intermediate stage 2-1, transmits the reception cell 2 to the intermediate stage 2-2, and transmits the reception cell 3 to the intermediate stage 2-3, in turn. At this time, the transmitting timing is deviated by 10 msec (milliseconds) for each cell. Hereinafter, similarly, the operation of transmitting the reception cells to the intermediate stages 2-1, 2-2 and 2-3 in turn is cyclically repeated. It should be noted that here, the cells of the oblique lines between the reception cells 3 and 4 are also treated as the cells to be transmitted to the intermediate stage 2-1. When the cell of the oblique lines does not actually exist, nothing may be transmitted to the intermediate stage 2-1. As for the remaining cells, the reception cell 4 is transmitted to the intermediate stage 2-2, and the reception cell 5 is transmitted to the intermediate stage 2-3. Also, the reception cell 6 is transmitted to the intermediate stage 2-1, the cells of the oblique lines between the reception cells 6, 7 are transmitted to the intermediate stage 2-2, and the reception cell 7 is transmitted to the intermediate stage 2-3.

In the example 1, the cell received by the input stage 1 is immediately transmitted to the intermediate stages 2. Thus, a delay due to the cell transmission wait based on the distributing algorism is 0.

An example 2 is a method referred to as a full ordered frames first (FOFF). The FOFF is a method in which each input stage 1 prepares a VOQ for each destination output stage and transmits the cells to the respective intermediate stages for each destination, in order.

FIG. 8 shows an operation example 2 of the load balanced type switching apparatus in the example 2. In order to simplify its description, a number M of the intermediate stages is assumed to be 3. Also, only the transfer operation from the input stage 1-1 to the mesh connection section 4 will be described below. The input stage has round robin pointers PTR(1), PTR(2) and PTR(3) for the destination output stages. Each round robin pointer is a pointer that defines the intermediate stage for a cell to be transmitted at a next time, for an individual destination output stage. For example, when a cell 1a destined to the output stage 3-1 is transmitted to the intermediate stage 2-1, a cell 1b that is a next cell destined to the output stage 3-1 is always required to be transmitted to the intermediate stage 2-2. In case of the FOFF, the intermediate stage 2 for the cell to be transmitted is strictly defined in accordance with the round robin pointer for each destination. Thus, there is a possibility that, although the cells are accumulated in the input stage, the cells cannot be transmitted. It should be noted that as the strict algorism definition, in the example 2, when N or more cells are accumulated in a certain VOQ, the N cells are distributed and transmitted to the intermediate stages with priority.

An operation example 2 of the load balanced type switching apparatus in the example 2 will be described below in detail. It should be noted that the input stage 1-1 has the 3 VOQs, and the received cells are distributed and stored in each of the 3 VOQs. Also, the round robin pointer exists in each of the 3 VOQs. Those round robin pointers are referred to as PTR(1), PTR(2) and PTR(3). Middle stage transmission time slots 1, 2 and 3 indicate the intermediate stages 2-1, 2-2 and 2-3, respectively.

When attention is paid to the cell 1a in FIG. 8, the intermediate stage transmission time slot is 1, and the PTR(1) or PTR(3) define 1 (the intermediate stage 2-1) as the intermediate stage of the destination. Here, the cell in the VOQ having the PTR(1) is transmitted to the intermediate stage 2-1. The cell 1b that is transmitted to the same output stage as the cell 1a is required to be transmitted to the intermediate stage 2-2. Thus, the PTR(1) is switched from 1 to 2. For this reason, in the intermediate stage transmission time slot 2, the PTR(1) becomes 2, the PTR(2) becomes 2, and the PTR(3) becomes 1. Until the cell 1b is transmitted, the PTR(1) must be 2. Here, the cell in the VOQ having the PTR(2) is transmitted to the intermediate stage 2-2. Since the cell 2b that is transmitted to the same output stage as a cell 2a is required to be transmitted to the intermediate stage 2-3, the PTR(2) is switched from 2 to 3. In the intermediate stage transmission time slot 3, the PTR(1) becomes 2, the PTR(2) becomes 3, and the PTR(3) becomes 1. When the intermediate stage transmission time slot is 3, the valid cell does not exist. Therefore, nothing is transmitted. Again, the intermediate stage transmission time slot becomes 1, and a cell 3a is transmitted. At this time, the cell in the VOQ having the PTR(3) is transmitted to the intermediate stage 2-1, and the PTR(3) is switched from 1 to 2. Next, the cell 1b is transmitted. The intermediate stage transmission time slot is 3, and the PTR(1) is 2. Therefore, the cell in the VOQ having the PTR(1) is transmitted to the intermediate stage 2-1, and the PTR(1) is switched from 2 to 3. Hereinafter, the similar operation is repeated.

FIG. 9 shows simulation results of the example 1 (Basic) and the example 2 (FOFF) when the number of the switch ports (L=M=N) is 4. An X-axis indicates a traffic load (that is assumed to be 100% when the cell is always received), and a Y-axis indicates an average delay amount. The traffic is a model of a random generation and a random destination. When the number of the ports is 4 and the traffic load is 70% or less, the delay is smaller in the example 1 than the example 2. However, at 70% or more, the delay amount is smaller in the example 2. When the traffic load becomes 70% or less, the delay amount of the example 1 in which the waiting is not performed in the input stage becomes smaller. The reason why the delay of the example 2 becomes smaller when the traffic load becomes 70% or more is as follows. That is, in the example 2, the input stage 1 distributes the cells strictly uniformly so that the difference between the numbers of the cells to be transmitted to the respective intermediate stages 2 is 1 or less for each destination output stage 3. That is, since the input stage 1 distributes the cells to the respective intermediate stages 2, there is the effect of suppressing the variation in the reception time between the cells arriving at the output stages 3 from the respective intermediate stages 2. Thus, the delay amount caused due to the reordering process in the output stage is reduced over the example 1. In the example 1, the input stage 1 transmits the cells in the delay of 0 without any waiting process. However, there is a case of the deviation occurrence in the numbers of the cells that are transmitted to the respective intermediate stages for each destination. Therefore, the wait time caused due to the reordering process in the output stage 3 becomes long over the example 2. As a result, in the example 1, the entire delay property becomes long.

From the foregoing description, it is known that, when the traffic load is high, the input stage strictly distributes the cells for each destination, and the entire delay can be consequently suppressed to the small value.

FIG. 10 shows simulation results of the example 1 (Basic) and the example 2 (FOFF) when the number of the switch ports (L=M=N) is 128. Differently from the case that the number of the switch ports is 4, when the number of the switch ports is 128, an average delay time is greater in the example 2 than the example 1. This reason is as follows. That is, the waiting time for the input stage 1 to uniformly distribute the cells is longer than the reduction in the waiting time for the reordering process in the output stage 3 because of the input stage 1 uniformly distributing the cells. In the example 2, the input stage 1 cannot transmit the cell unless the round robin pointer for each destination output stage 3 is coincident with the number of the intermediate stage of the transmission destination that can be defined in the cell time slot. Thus, the fact that, as the number of the switch ports becomes greater, the possibility that the cell cannot be transmitted becomes higher, which causes the increase in the delay time. When the number of the switch ports is 4, the cell can be transmitted one time per 4 cell time slots. However, when the number of the switch ports is 128, the cell can be transmitted one time per 128 cell time slots.

In the example 1, since the cells are not uniformly distributed to the respective intermediate stages 2, the reordering process delay time at the output stage 3 becomes long when the traffic load is high. Also, since the maximal delay time at the output stage 3 cannot be defined, the algorism of the reordering process becomes complex.

In the example 2, it is necessary to produce a wait time at the input stage 1 so that the cells are uniformly distributed to the respective intermediate stages 2. In particular, as the number of the switch ports increases, the influence resulting from this wait time becomes severer, and the entire delay property is deteriorated. This reason is as follows. That is, since the input stage 1 can transmit the cell to only one intermediate stage 2 specified by the round robin pointer for each destination, the transmission of the cell must be waited until transmission of the cell is permitted.

In this way, the example 1 (Basic) has the problem that its performance is low when the number of the switch ports is small, and the example 2 (FOFF) has the problem that its performance is low when the number of the switch ports is great.

As the related technique, Japanese Laid Open Patent Application (JP-P 2002-164914A) discloses a packet switching apparatus. This packet switching apparatus contains a plurality of receiving sections, a plurality of transmitting sections and a switching section. The plurality of receiving sections receive packets at input port units. The plurality of transmitting sections transmit the packets to output port units. The switching section transfers the packet received from the receiving section to the transmitting section corresponding to a desirable output direction.

Each of the receiving sections contains a direction determining section and a packet accumulating unit. The direction determining section determines an output direction in accordance with a destination address data of the packet. The packet accumulating unit is provided with a plurality of buffers for accumulating the packets for each output direction, and then read the accumulated packets based on an empty state of the switching section.

The switching section contains input controllers corresponding to the number of the receiving sections; and output controllers corresponding to the number of the transmitting sections. The input controllers for the number of the receiving sections contain a plurality of small capacity buffers (the capacity of the buffer>the capacity of the small capacity buffer) that correspond to the plurality of buffers in the respective receiving sections, and individually report the empty state in the small capacity buffers to the corresponding receiving section. The output controllers for the number of the transmitting sections receive the packets accumulated in the small capacity buffers in the respective input controllers and individually output the packets to the transmitters of the corresponding output directions.

Also, Japanese Laid Open Patent Application (JP-A-Heisei, 10-107846) discloses a packet processing apparatus. This packet processing apparatus contains a plurality of line handlers, a counter, a rate register, a comparator and a selector. The plurality of line handlers receive data on a communication line and transmit the data onto the communication line. The counter is provided for the line handler to hold a total value of the transmission packet amounts measured for each packet destination. The rate register holds a use rate between the plurality of line handlers having the same destination. The comparator refers to the respective values of the rate register and the counter to determine the line handler to be used at a next time. The selector switches the transmission destination of the packet in accordance with the determination of the comparator. Also, in this packet processing apparatus, the use rate for the rate register is set in accordance with the loads of the respective communication lines having the same destination, and the plurality of communication lines are switched in accordance with the loads of the respective communication lines, and then the packets are transmitted.

Also, Japanese Laid Open Patent Application (JP-P2002-223234A) discloses a packet transfer apparatus which has a transmission apparatus and a reception apparatus which are connected through a plurality of lines. A section converts packet data to have a frame configuration. A transmission section transmits the packet data of the frame configuration through the line. A hold section holds a total data amount of the packet data transmitted. The transmission section transmits the packet data by using one line having the least total data amount.

Also, Japanese Laid Open Patent Application (JP-P2001-298464A) discloses a packet switching apparatus. When a preset number of cells are stored or when a preset time elapses from reception of a first cell, the cells are transmitted. At this time, an input interface detects a traffic amount of cells received from a cross point switch. A managing section outputs traffic data indicating a traffic amount for each output interface. The input interface changes a cell wait time for each output interface based on the traffic data.

### SUMMARY

It is an exemplary object of the present invention to provide a load balanced type switching apparatus in which an input stage transmits a reception cell to an intermediate stage without any delay.

Another exemplary object of the present invention is to provide a load balanced type switching apparatus in which cells are uniformly distributed from input stages to intermediate stages for each destination, to reduce a delay time due to a reordering process at an output stage.

Still another exemplary object of the present invention is to provide a load balanced type switching apparatus in which a total delay time can be reduced.

In an exemplary aspect of the present invention, a load balanced type switching apparatus includes input stages, intermediate stages connected with the input stages in a mesh manner, and output stages connected with the intermediate stages in a mesh manner. One of the input stages includes a destination detecting section configured to detect a destination one of the output stages corresponding to a reception cell; a cell transmitting section having a storage unit and connected with the intermediate stages in the mesh manner, and configured to store the reception cell from the destination detecting section in the storage unit based on the destination output stage of the reception cell; and a transmission cell determining section configured to manage the cells stored in the storage unit for each destination output stage by using a transmission counter for every output stage and for every intermediate stage, and to select a transmittable cell from among the cells stored in the storage unit, such that a number of the cells to be transmitted to each of the intermediate stages falls within a predetermined range for every destination output stage. The cell transmitting section transmits the transmittable cell to one of the intermediate stages based on the management result.

Another exemplary aspect of the present invention relates to a switching method in a load balanced type switching apparatus comprising input stages, intermediate stages connected with the input stages in a mesh manner, and output stages connected with the intermediate stages in a mesh manner. The switching method includes detecting a destination one of the output stages corresponding to a reception cell; storing the reception cell in a storage unit based on the destination output stage of the reception cell; determining a transmittable cell from among the cells stored in the storage unit for each destination output stage by using a transmission counter for every output stage and for every intermediate stage such that a number of the cells to be transmitted to each of the intermediate stages falls within a predetermined range for every destination output stage; and transmitting the transmittable cell to one of the intermediate stages based on the management result.

Another exemplary aspect of the present invention relates to a computer-readable software product for realizing a switching method in a load balanced type switching apparatus comprising input stages, intermediate stages connected with the input stages in a mesh manner, and output stages connected with the intermediate stages in a mesh manner. The switching method includes detecting a destination one of the output stages corresponding to a reception cell; storing the reception cell in a storage unit based on the destination output stage of the reception cell; determining a transmittable cell from among the cells stored in the storage unit for each destination output stage by using a transmission counter for every output stage and for every intermediate stage such that a number of the cells to be transmitted to each of the intermediate stages falls within a predetermined range for every destination output stage; and transmitting the transmittable cell to one of the intermediate stages based on the management result.

### BRIEF DESCRIPTION OF THE DRAWINGS

The above and other objects, advantages and features of the present invention will be more apparent from the following description of the exemplary embodiments made in conjunction with the accompanying drawings, in which:

FIG. 1 is a block diagram showing a configuration of an input buffer type switching apparatus in a related art;

FIG. 2 is a block diagram showing a configuration of an input buffer type switching apparatus using VOQs in a related art;

FIG. 3 is a block diagram showing a configuration of an output buffer type switching apparatus in a related art;

FIG. 4 is a block diagram showing a configuration of a shared buffer type switching apparatus in a related art;

FIG. 5 is a block diagram showing a configuration example of a load balanced type switching apparatus in a related art;

FIG. 6 is a block diagram showing a configuration of a load balanced type switching apparatus in which a line card has an input stage, an intermediate stage, and an output stage;

FIG. 7 is a diagram showing an operation example 1 of the load balanced type switching apparatus;

FIG. 8 is a diagram showing an operation example 2 of the load balanced type switching apparatus;

FIG. 9 is a diagram showing simulation results of the operation example 1 (Basic) and the operation example 2 (FOFF) when the number of switch ports (L=M=N) is 4;

FIG. 10 is a diagram showing simulation results of the operation example 1 (Basic) and the operation example 2 (FOFF) when the number of switch ports (L=M=N) is 128;

FIG. 11 is a block diagram showing a configuration example of an input stage of a load balanced type switching apparatus according to a first exemplary embodiment of the present invention;

FIG. 12 is an operation flowchart of a cell receiving process by a transmission cell determining section in the input stage;

FIG. 13 is an operation flowchart of a transmission cell selecting process by the transmission cell determining section of the input stage;

FIG. 14 is an operation flowchart of a cell transmission determining process;

FIG. 15 is a diagram showing an operation example of the load balanced type switching apparatus of the present invention;

FIG. 16 is an operation flowchart of a process of updating a control memory when the transmission cell determining section determines transmission of a cell having a destination output stage i to an intermediate stage j;

FIG. 17 is a diagram showing another operation example of the load balanced type switching apparatus of the present invention;

FIG. 18 is a diagram showing an operation example when a check order list is used;

FIGS. 19A to 19G are diagrams showing a specific example of the check order list;

FIG. 20 is a diagram showing simulation results of an example 1 (Basic), an example 2 (FOFF) and the load balanced type switching apparatus (New) of the present invention, when the number of switch ports (L=M=N) is 4;

FIG. 21 is a diagram showing simulation results of the example 1 (Basic), the example 2 (FOFF) and the load balanced type switching apparatus (New) of the present invention, when the number of switch ports (L=M=N) is 128;

FIG. 22 is an operation flowchart of a first example of the transmission cell selecting process by the load balanced type switching apparatus according to the first exemplary embodiment of the present invention;

FIG. 23 is an operation flowchart of a second example of the transmission cell selecting process by the load balanced type switching apparatus according to the first exemplary embodiment of the present invention;

FIG. 24 is a block diagram showing a configuration of an input stage of the load balanced type switching apparatus in a second exemplary embodiment of the present invention;

FIG. 25 is an operation flowchart of a transmission cell selecting process by a transmission cell determining section in the second exemplary embodiment;

FIG. 26 is a block diagram showing a configuration of an input stage in the load balanced type switching apparatus according to a third exemplary embodiment of the present invention; and

FIG. 27 is an operation flowchart of a transmission cell selecting process by the transmission cell determining section in the third exemplary embodiment.

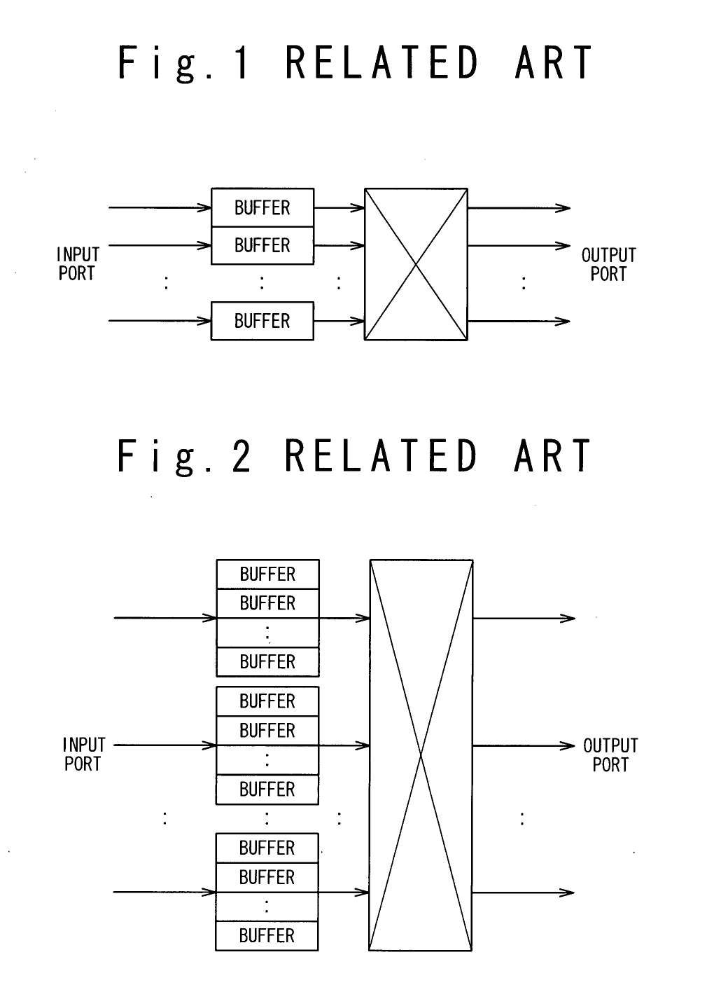

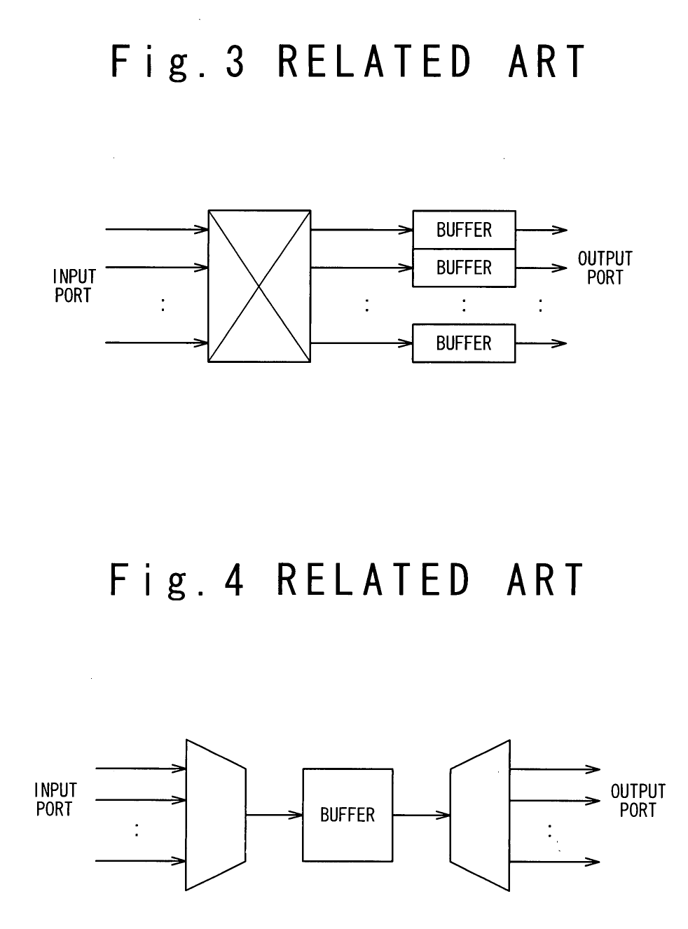

### EXEMPLARY EMBODIMENTS

Hereinafter, a load balanced type switching apparatus according to exemplary embodiments of the present invention will be described in detail with reference to the attached drawings.

### First Exemplary Embodiment

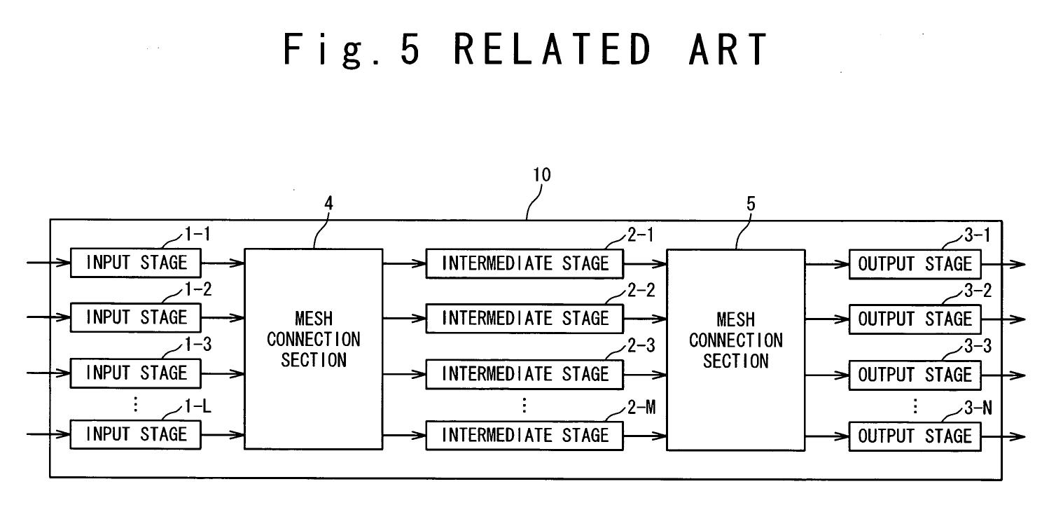

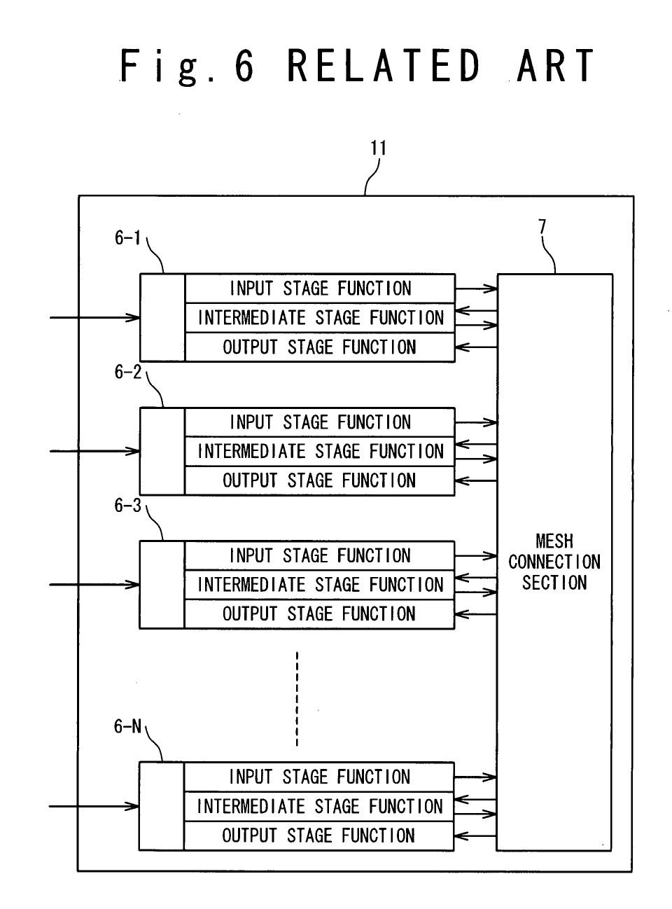

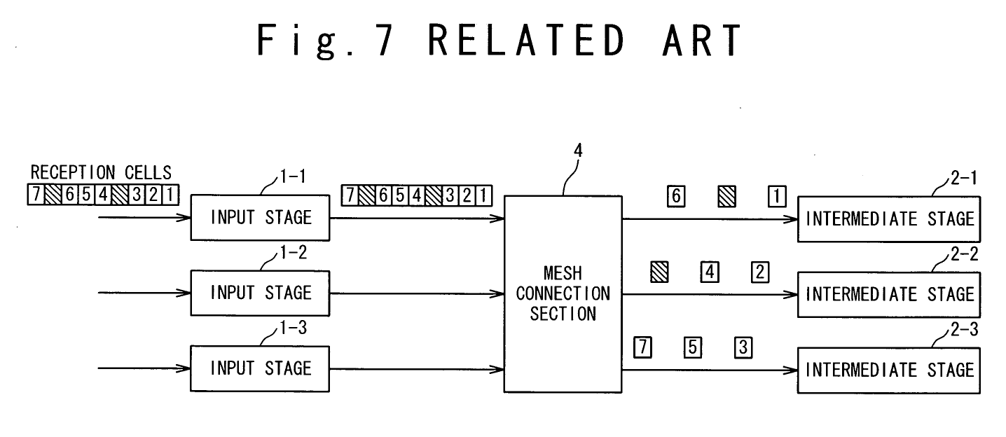

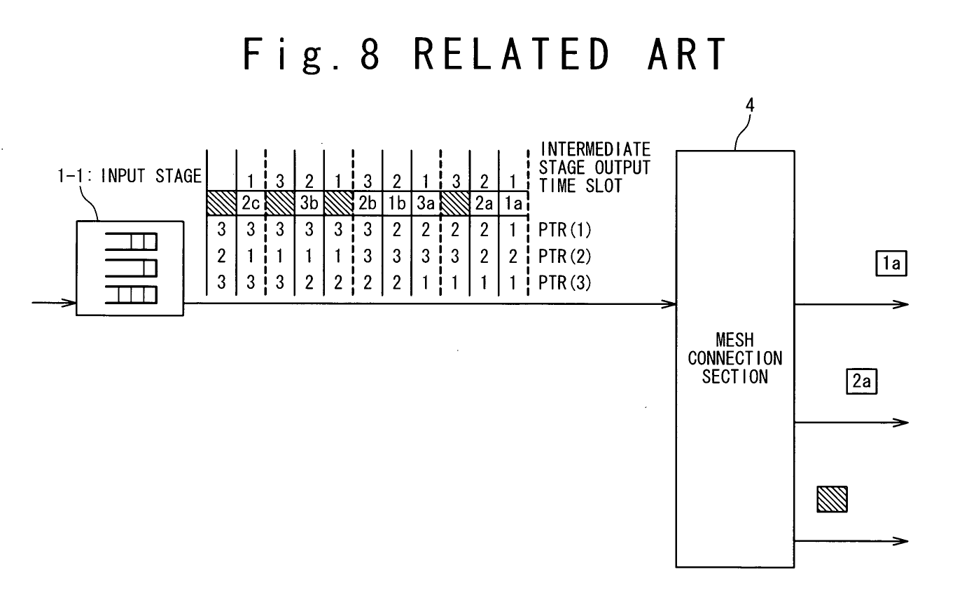

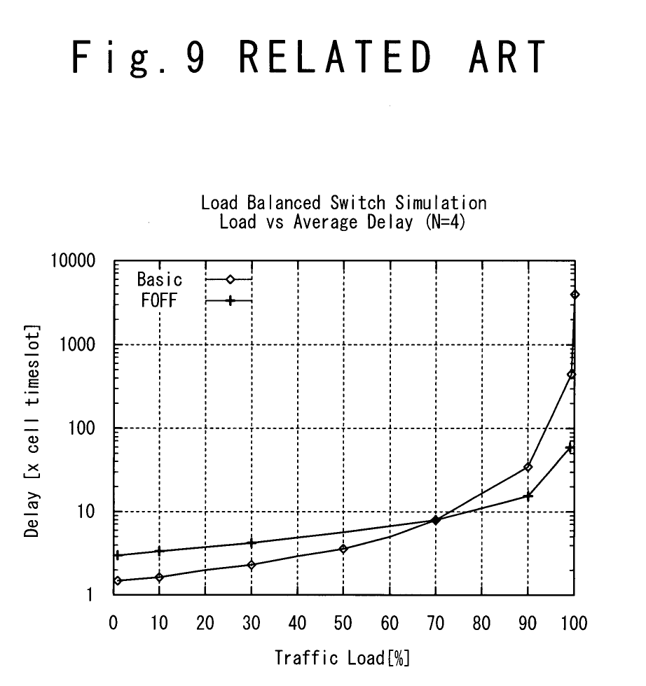

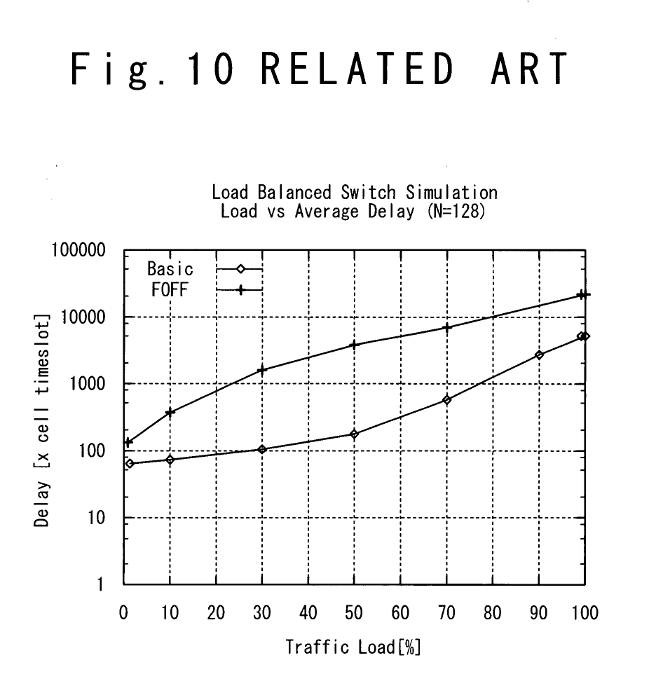

The load balanced type switching apparatus according to a first exemplary embodiment of the present invention will be described. The basic configuration of the load balanced type switching apparatus of the present invention is as shown in FIG. 5. The load balanced type switching apparatus of the present invention has one feature in an input stage 1. It should be noted that when the configuration shown in FIG. 6 is adopted, an input stage function of a line card 6 corresponds to the input stage 1.

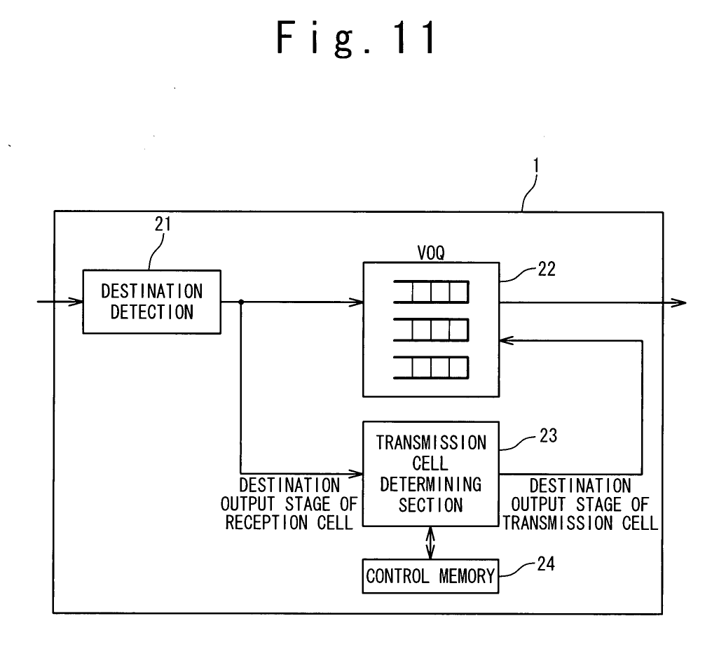

FIG. 11 shows a configuration of the input stage 1 in the load balanced type switching apparatus according to the first exemplary embodiment of the present invention. The input stage 1 contains a destination detecting section 21, a VOQ (virtual output queue) unit 22, a transmission cell determining section 23 and a control memory 24.

The destination detecting section 21 detects one of the output stages as a destination of a reception cell supplied from an external unit to the input stage 1 and outputs the reception cell to the VOQ unit 22 and the transmission cell determining section 23. The VOQ unit 22 receives the cell from the destination detecting section 21, and stores it in a VOQ buffer for each destination output stage. Also, the VOQ unit 22 reads the head cell of the VOQ buffer associated with a specified destination output stage in response to a read request from the transmission cell determining section 23, and transmits to a mesh connection section 4. The transmission cell determining section 23 manages the number of cells in each of the VOQ buffers based on the destination output stage data of each cell received from the destination detecting section 21 and determines from which of the VOQ buffers the cell is transmitted into cell time slot. The transmission cell determining section 23 manages the following data in the control memory 24: that is, the number of cells voq_cnt [i] stored in the VOQ buffer for each destination output stage i, cell transmission counter value out_cnt [i] [j] for each output stage i and for each intermediate stage j (j=1 to K: K is the number of the intermediate stages), and the minimum value min_cnt [i] (the minimum value of out_cnt [i] [1], out_cnt [i][2], . . . , and out_cnt [i] [K]) and the maximum value max_cnt [i] (the maximum value of out_cnt [i] [1], out_cnt [i] [2], . . . , and out_cnt [i] [K]) of the transmission counter value out_cnt [i] [j] for each destination output stage i. The number of VOQ accumulated cells for each destination output stage is counted up when the cell is received from the destination detecting section 21, and it is counted down when being determined to be a read target from the VOQ buffer. The transmission counter for each intermediate stage and for each output stage manages the transmission counter value for each cell transfer route defined by the intermediate stage and the output stage. At this time, it is preferable that the cells transmitted from the input stages 1 to the intermediate stage 2 are similar in size. However, they are not always limited to the fixed length cell. For example, in case of a variable length cell, the number of the cells is not counted, and the size (data length) of the cell may be counted. Here, since a good result in view of the performance can be expected in case of the fixed length cell, the fixed length cell is only exemplified here.

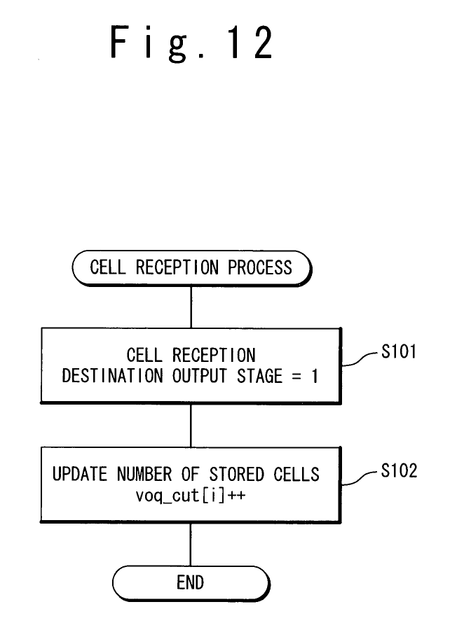

FIG. 12 shows an operation flowchart of a cell receiving process by the transmission cell determining section 23.

### (1) Step S101

The transmission cell determining section 23 recognizes that a cell is received destined to a destination output stage i.

### (2) Step S102

When recognizing that the cell destined to the destination output stage i is received, the transmission cell determining section 23 increments the number of cells in the VOQ buffer corresponding to the destination output stage i (voq_cnt[i]++).

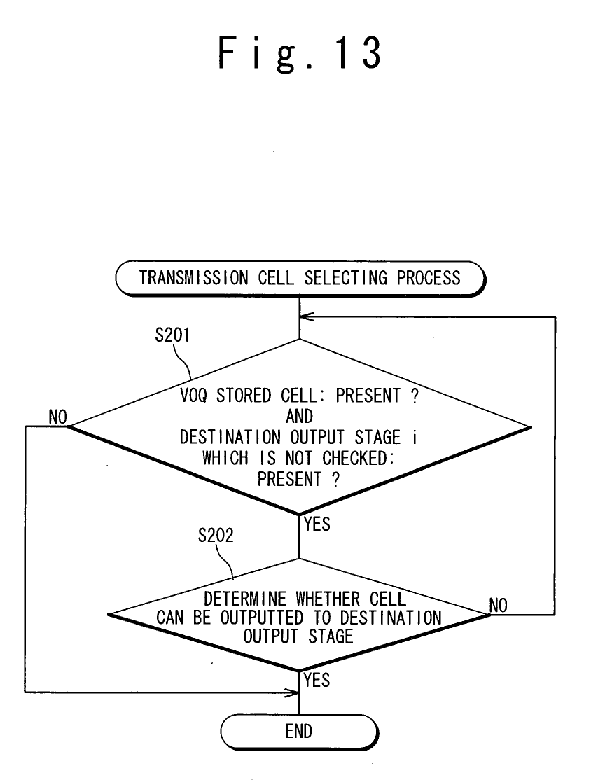

FIG. 13 shows an operation flowchart of a transmission cell selecting process by the transmission cell determining section 23.

### (1) Step S201

The transmission cell determining section 23 checks whether or not any cell stored in the VOQ buffer associated with a certain destination output stage i exists (voq_cnt[i]>0) and whether or not the destination output stage that is not yet checked exists. If such an output stage does not exist, the process is ended.

### (2) Step S202

If such an output stage exists, whether or not the cell having the destination output stage i can be transmitted in a current intermediate stage cell time slot is determined. If the cell is transmittable, the cell is transmitted and the process is consequently ended. If the cell cannot be transmitted, whether or not a different destination output stage exists is again checked. Then, the process is repeated until the transmittable cell can be found out or until the cell targeted for the check is reduced to 0.

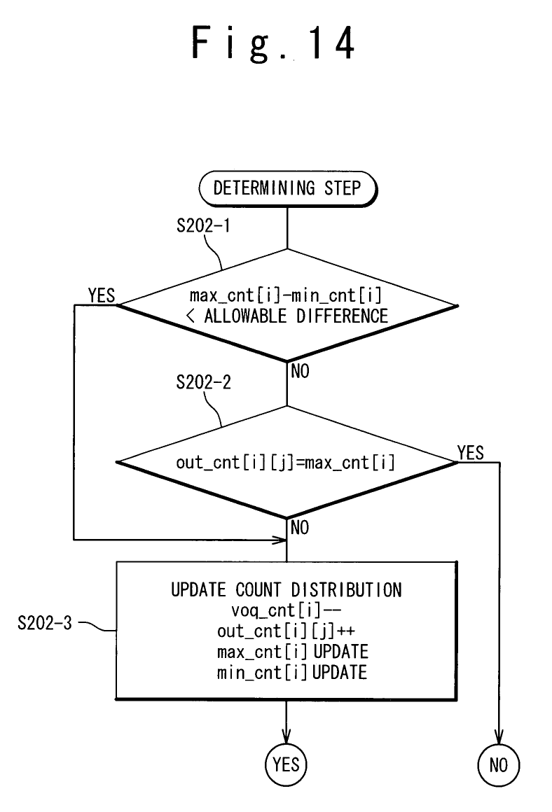

FIG. 14 shows a flowchart of a potion of the cell transmission allowance determining process (Step S202).

### (1) Step S202-1

At first, whether or not a difference between a maximum value and a minimum value (max_cnt[i]−min_cnt[i]) is smaller than an allowable difference value is determined. If the difference is smaller than the allowable difference value, the cell can be unconditionally transmitted.

### (2) Step S202-2

Otherwise, whether or not a transmission counter value out_cnt[i][j] corresponding to the destination output stage i and the intermediate stage j in a current cell time slot coincides with the maximum value max_cnt[i] of the counter is further checked. When the counter value out_cnt[i][j] coincides with the maximum value max_cnt[i], the difference exceeds the allowable difference value if the cell destined to the destination output stage i is transmitted to the intermediate stage j. Thus, the transmission of the cell is determined to be not allowed (No). If the count out_cnt[i][j] does not coincide with the maximum value max_cnt[i], the transmission of the cell to the intermediate stage j is determined to be allowed (Yes).

### (3) Step S202-3

If the cell destined to the destination output stage i is determined to be transmitted to the intermediate stage j, the number of cells stored in the VOQ buffer is decremented (voq_cnt[i]−−), and the transmission counter value is incremented (out_cnt[i][j]++). Also, the maximum value max_cnt[i] and the minimum value min_cnt[i] are updated as necessary. That is, depending on the counter value out_cnt[i][j], the maximum value max_cnt[i] and the minimum value min_cnt[i] are updated. For example, if the counter value out_cnt[i][j] becomes greater than the maximum value max_cnt[i] at that time, the counter value out_cnt[i][j] is set to the maximum value max_cnt[i] (max_cnt[i]=out_cnt[i][j]). Similarly, if the counter value out_cnt[i][j] becomes smaller than the minimum value min_cnt[i] at that time, the counter value out_cnt[i][j] is set to the minimum value min_cnt[i] (min_cnt[i]=out_cnt[i][j]). Through the above control, a distributing process can be realized to uniformly suppress the difference between the intermediate stages in the number of transmission cells within the allowable difference value for each destination output stage.

It should be noted that in this flowchart, a process is performed of determining for every cell time slot, whether the transmittable cell by using the cell time slot is present. However, under the condition that a plurality of cells are accumulated or stored in the VOQ buffer, the transmittable cells may be determined for the plurality of time slots. By allowing the transmission reservation for the plurality of cell time slots to be performed in one cell time slot, the cells can be transmitted in the throughput of 100% when an average of the determining process times is within one cell time slot, even if an increase or decrease occurs in the determining process time to determine a cell to be transmitted in each cell time slot. Also, when the plurality of cells are continuously transmitted to the same destination, it is possible to reduce the determining process time for each cell time slot. For example, when the difference between the maximum value max_cnt[i] and the minimum value min_cnt[i] is smaller than the allowable difference value in a certain destination output stage i, the difference never becomes greater than the allowable difference value as long as the cells are continuously transmitted. Thus, by performing the once determining process, it is possible to determine that all of the cells accumulated in the VOQ buffer for the destination output stage i can be continuously transmitted.

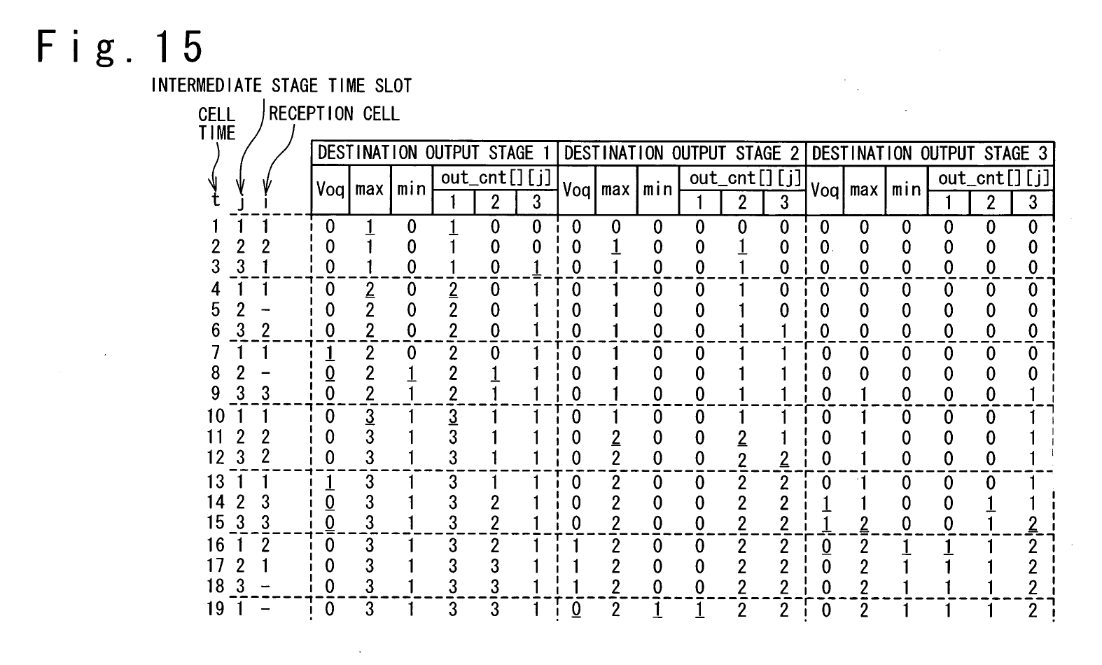

FIG. 15 shows an operation example of the load balanced type switching apparatus according to the first exemplary embodiment of the present invention. The number of the switch ports (L, M and N) is 3. Also, it is supposed that the intermediate stage time slots change in an order of 1, 2, 3, 1, 2 and 3 in the intermediate stage j to which the cells can be transmitted from a certain input stage. It is also supposed that a cell having the destination output stage i=1 arrives at a time t=1. At this time, the intermediate stage time slot is “1”, and the cell is transmittable. Therefore, the transfer counter is incremented to the counter value out_cnt[1][1]=1, and the maximum value max_cnt[1] is set to “1”.

At a time t=2, a cell having the destination output stage i=2 arrives. At this time, the intermediate stage cell time slot is “2”, and the cell is transmittable. Therefore, the transmission counter is incremented to the counter value out_cnt[2][2]=1, and the maximum value max_cnt[2] is set to “1”.

At t=7, a cell having the destination output stage i=1 arrives. At this time, the intermediate stage cell time slot is “1”. However, the difference between the maximum and the minimum is “2”, i.e., max_cnt[1]−min_cnt[1]=2, and is equal to the allowable difference value. Also, the transmission counter value out_cnt[1][1]=2 having the intermediate stage j=1 and the destination output stage i=1 is equal to the maximum value max_cnt[1]=2. Thus, the cell cannot be transmitted. Therefore, a reception cell is not transmitted, but is accumulated in the VOQ buffer. Also, the transmission counter is incremented to voq_cnt[1]=1.

In a next cell time slot t=8, the intermediate stage cell time slot becomes 2. The value of the transmission counter of the intermediate stage j=2 is out_cnt[1][2]=0. Thus, the transmission of the cell is determined to be possible.

At t=14, the cell destined to the destination output stage i=3 is received. At this time, the intermediate stage cell time slot is 2. Since the stored count voq_cnt[3][2]=1 and this is smaller than the maximum value max_cnt[3]=2, the received cell can be transmitted. However, at a time t=13, the cell accumulated in the VOQ buffer for the destination output stage 1 is selected to be transmitted. Therefore, the received cell destined to the destination output stage i=3 is not transmitted, and this is accumulated in the VOQ buffer (voq_cnt[3]=1).

As in a time t=14, when the cell destined to a destination output stage i2 (in this case, i2=3) is received under the condition that the cell having a destination output stage i1 (in this case, i1=1) is accumulated in the VOQ buffer, there may be a case that the number of the transmittable cells is 2 or more. As the selecting method in case that the plurality of cells can be selected, the following methods are considered.

(a) Random Selection

The reason of the random selection is to remove the deviation between the ports.

(b) Selection by Round Robin Method by Using Previous Selected Cell Having Lowest Priority

When the cell has been outputted from the port 2 at a previous time, a checking process will be performed by a round robin method (3, 1 and 2) from the port 3 at a next time. The reason of selection by the round robin method is to remove a deviation between the ports, similarly to a case of random selection, and an easy installation is possible.

(c) Control of Giving Priority to Cell Accumulated in VOQ Rather than Received Cell in Addition to Above Control

The reason why a priority is given to a cell accumulated in the VOQ buffer rather than the received cell is to prevent increase in delay of the accumulated cell because the cell continues to remain in the switching apparatus. A different selecting method will be described in another example. Here, a transmission cell determining method will be described.

In the present invention, FIG. 16 shows a flowchart of a first example of an updating process (S202-3) for the control memory when the transmission cell determining section 23 determines transmission of the cell having the destination output stage i to the intermediate stage j. The transmission cell determining section 23 in the first example has a counter distribution cnt_num [i][ ] that implies a distribution of cells transmitted to the intermediate stage, in addition to the foregoing count voq_cnt[i], the count value out_cnt[i][j], maximum value max_cnt[i] and minimum value min_cnt[i] in the control memory. For example, the counter distributions cnt_num [2][3]=5 and cnt_num [2][4]=3 imply that there are five intermediate stages whose counter values are 3 and three intermediate stages whose counter values are 4 in the cell transmission counter to each intermediate stage destined to the destination output stage 2.

It should be noted that the count out_cnt[i][j], the maximum value max_cnt[i] and the minimum value min_cnt[j] are parameters that imply the numbers of the transmitted cells, and are also the parameters for performing the distribution control not to exceed the allowable difference value. Actually, as the value stored in the control memory, a K value when meets K>maximum allowable difference value is used as a value after the modulo K calculation. As the value after the modulo K calculation, a remainder when each parameter is divided by K is used. For example, in case of K=4, the counter value 4 is converted into 0 (4 mod 4=0), and the counter value 13 is converted into 1 (13 mod 4=1).

An operation of the control memory updating process (S202-3) when the transmission cell determining section 23 transmits the cell having the destination output stage i to the intermediate stage j will be described below.

### (1) Step S202-3-1

A value of 1 is subtracted from the VOQ accumulation cell count (voq_cnt[i]) having the destination output stage i of a target transmission cell. That is, the VOQ accumulation cell number of the destination output stage i of the target transmission cell is decremented (voq_cnt[i]−−).

### (2) Step S202-3-2

Next, whether or not the transmission counter value out_cnt[i][j] associated with the output stage i and the intermediate stage j is same as the maximum value max_cnt[i] is checked.

### (3) Step S202-3-3

If they are the same, “1” is added to the maximum value max_cnt[i]. That is, the maximum value is incremented (maximum value max_cnt[i]++).

### (4) Step S202-3-4

Next, whether or not the transmission counter value out_cnt[i][j] associated with the output stage i and the intermediate stage j is same as the minimum value min_cnt[i] and whether or not the transmission counter out_cnt[i][j] having the minimum value is only one with respect to the destination output stage i are checked.

### (5) Step S202-3-5

Next, if the transmission counter value out_cnt[i][j] associated with the output stage i and the intermediate stage j is equal to the minimum value min_cnt[i] and there is only one transmission counter out_cnt[I][j] having the minimum value with regard to the destination output stage i, “1” is subtracted from the minimum value (minimum value min_cnt[i]−−).

### (6) Step S202-3-6

Finally, a counter distribution cnt_num [i][ ] is updated.

### (7) Step S202-3-7

The value of “1” is added to the transmission counter value out_cnt[i][j] (out_cnt[i][j]++).

In the first example, the updating process of the control memory when the transmission cell is determined is attained independently of the number M of the intermediate stages. Thus, the process can be performed within a fixed time.

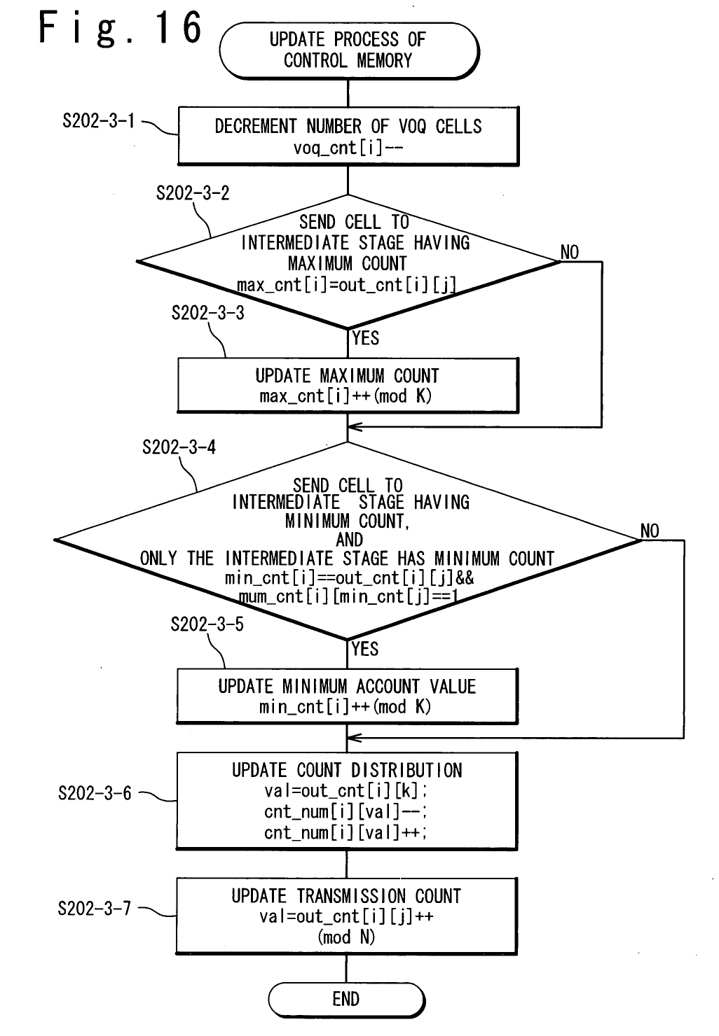

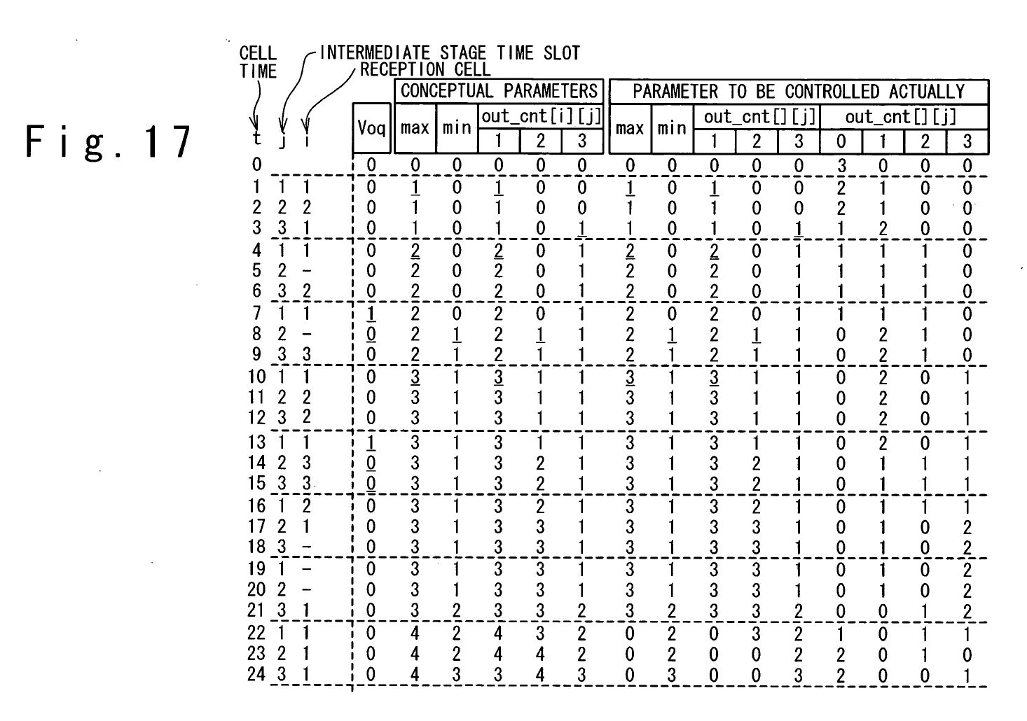

FIG. 17 shows an operation example in this first example. In this operation example 1, the changes in the maximum value max_cnt, the minimum value min_cnt, the transmission counter value out_cnt and the counter distribution cnt_num which are the parameters after the module K calculation, and which are actually managed in the control memory, are indicated on the right sides of the conceptual parameters of the maximum value max_cnt, the minimum value min_cnt and the counter value out_cnt. Only the parameter changes of the destination output stage i=1 are indicated for the sake of a simple explanation.

At a time t=0 in the initial state, all of the transmission counter values out_cnt[1][1], out_cnt[1][2] and out_cnt[1][3] are 0. Thus, in the counter distribution, the counter distribution cnt_num [1][0]=3, and the counter distributions cnt_num [1][1]=0, cnt_num [1][2]=0 and cnt_num [1][3]=0.

At a time t=1, the counter value out_cnt[1][1] is changed from 0 to 1. Thus, the counter distribution cnt_num [1][0] is decremented to 2, and the counter distribution cnt_num [1][1] is incremented to 1.

At a time t=22, the conceptual counter value out_cnt[1][1]=4. However, the value that is registered in the control memory becomes the counter value out_cnt[1][1]=0, because of the module K(=4) calculation. The counter distribution becomes cnt_num [1][0]=1 in order to calculate the distribution of the transmission counter values after the module K calculation.

Here, a method of determining a VOQ check order will be described. In a second example, a process of determining the check order will be described when the transmission cell determining section 23 checks whether or not the cells in the VOQ are transmittable. The transmission cell determining section 23 is assumed to manage the check order with respect to the destination output stage in accordance with a check order list, in order to determine the destination output stage to be checked.

The transmission cell determining section 23 performs a check process sequentially from the head of the check order list and repeats the check process until a transmittable cell is discovered. When the transmittable cell is discovered and the cell in the corresponding VOQ buffer is reduced to 0, the data of the corresponding destination output stage is deleted from the check order list. Irrespectively of the discovery of the transmittable cell, if the cell remains in the corresponding VOQ buffer, the data of the corresponding destination output stage is shifted to the end of the check order list.

Also, in case of receiving the cell destined to the destination output stage i that is the cell count voq_cnt[I]=0, the destination output stage i is added to the check order list.

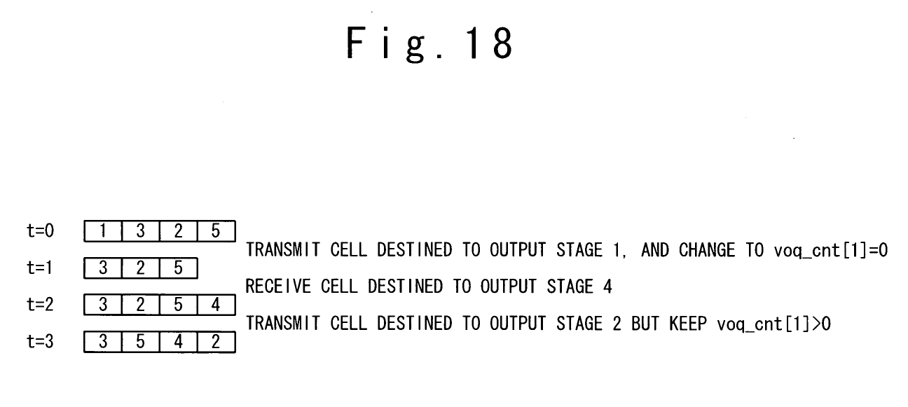

FIG. 18 shows an operation in case of using the check order list. At t=0, the cell destined to the output stage 1 is transmitted, and the cell count voq_cnt[1]=0 is established. Thus, the destination output stage i=1 at the head of the check order list is deleted from the list.

At a time t=1, the cell destined to the output stage 4 is newly received, and the cell count voq_cnt[4]=1 is established. Thus, the cell is added to the end of the check order list.

At a time t=2, the cell having the destination output stage 2 is transmitted. However, although the cell count voq_cnt[2]>0 is still kept, the destination output stage i=2 in the check order list is shifted to the end of the check order list.

In this way, since the check order list is used, the transmission cell determining section 23 can determine the transmission cells at a high rate, by using only the cell accumulated in the VOQ buffers as a check target. Also, the cell still accumulated in the VOQ buffer for the longest time can be transmitted with priority. Also, the longest length of the check order list is K. Thus, this implies that there is a transmission chance once per K times even under the worst condition.

In a third example, similarly to the second example, the transmission cell determining section 23 uses the check order list and checks whether or not the cell can be transmitted in the order of the destination output stage i registered in the list. However, when the order of the check order list is defined, it is supposed that a priority parameter for each destination output stage is used to carry out the check in an order starting from the highest value of the priority parameter or an order starting from the lowest value.

As the priority parameter, for example, the followings may be considered.

(a) The order of a more amount of cells stored in the VOQ buffers
(b) The order starting from the largest of differences between the maximum value and the minimum value (max_cnt[I]−min_cnt[I])
(c) In addition to the above order, when the differences are equal to each other, the order starting from the smallest counter distribution cnt_num [i] [min_cnt[i]] of the intermediate stages having the minimum count value

### Parameter Example

The order starting from the largest one (max_cnt[i]−min_cnt[i])×K+(K−cnt_num [i] [min_cnt[i]])

Since the foregoing parameters are used, the destination output stage having the highest possibility that the cell cannot be transmitted because a deviation is caused in the cell transmission is checked with priority. Therefore, there is an effect of the reduction in the maximum delay time from when a cell is received by the input stage to when the cell is transmitted.

Also, when rearrangement based on the priority parameters is performed for each cell time slot, the following priority parameters are considered.

(a) The order starting from the largest value of max_cnt[i]−out_cnt[i][j]
(b) In addition to the above description, when the above values are equal to each other, the destination output stage having the smaller number of the intermediate stages is checked which have smaller values than the counter value out_cnt[i][j] (j′ satisfies out_cnt[i][j]>out_cnt[i][j′])

By using the foregoing parameter, the cell can be checked with priority, wherein the cell has the highest possibility that the cell cannot be transmitted because of a deviation caused in the cell transmission but the cell is transmitted to the intermediate stage j to improve the deviation.

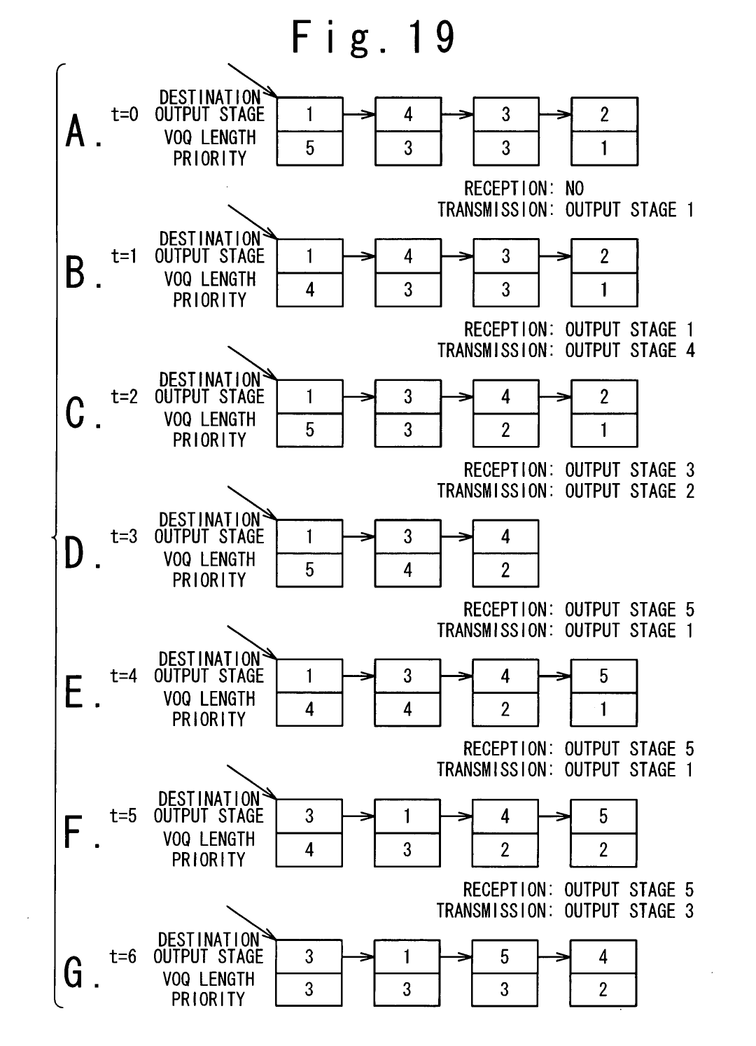

A specific example of the cell transmitting process based on the priority parameter in the check order list will be described below. FIG. 19 shows an example of the order starting from the most of the amounts of cells stored in the VOQ buffers as a priority parameter. That is, here, the VOQ buffer length is defined as a priority parameter. At first, it is supposed that the priority parameter (VOQ buffer length) of the destination output stage 1 is 5, the priority parameters of the destination output stages 3 and 4 are 3, and the priority parameter of the destination output stage 2 is 1.

At a time t=0, there is no reception of the cell, and a cell destined to the output stage 1 is transmitted. Thus, the priority parameter of the destination output stage 1 is decreased by 1.

At a time t=1, a cell destined to the output stage 1 is received, and the cell destined to the output stage 4 having the highest priority parameter next to the destination output stage 1 is transmitted. Thus, the priority parameter of the destination output stage 4 is decreased by 1.

At a time t=2, since the priority parameter of the destination output stage 4 is decreased by 1, the order between the destination output stage 3 and the destination output stage 4 is changed. Since the priority parameter is already 5 (the VOQ buffer length=5) in the cell destined to the output stage 1, the cell destined to the destination output stage 3 is received. Also, the cell destined to the output stage 2 having the highest priority parameter next to the destination output stage 4 is transmitted, and the priority parameter of the destination output stage 2 is decreased by 1. At this time, since the priority parameter of the destination output stage 2 becomes 0, the destination output stage 2 is erased from the list.

At a time t=3, since the destination output stage 2 is deleted from the list, the number of the destination output stages is three of 1, 3 and 4. Thus, a cell destined to the output stage 5 is newly received, and the cell destined to the output stage 1 having the highest priority parameter is transmitted.

At a time t=4, the cell destined to the output stage 5 having the lowest priority parameter is received, and the cell destined to the output stage 1 having the highest priority parameter is transmitted.

At a time t=5, the cell destined to the output stage 5 is received, and the priority parameter of the destination output stage 5 becomes higher than the priority parameter of the destination output stage 4. Thus, the order is changed. Also, since the priority parameter of the destination output stage 1 becomes lower than the priority parameter of the destination output stage 3, the order is changed. Thus, the cell destined to the output stage 3 is transmitted.

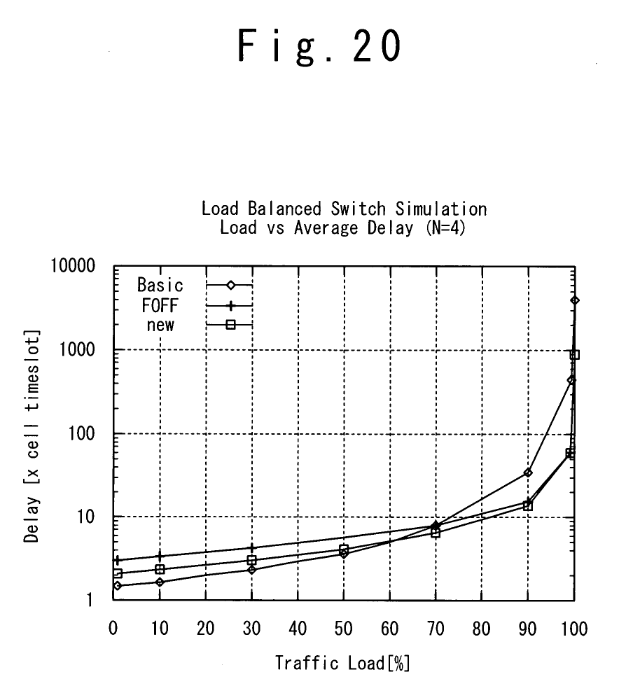

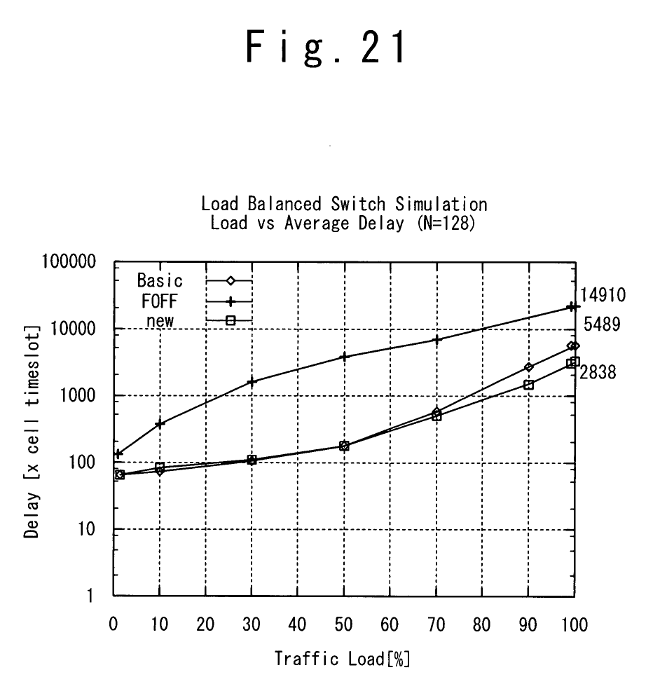

FIG. 20 shows simulation results of an example 1 (Basic), an example 2 (FOFF) and the load balanced type switching apparatus (New) of the present invention, when the number of the switch ports (L=M=N) is 4. FIG. 21 shows the simulation results of the example 1 (Basic), the example 2 (FOFF) and the load balanced type switching apparatus of the present invention, when the number of the switch ports (L=M=N) is 128. With reference to FIGS. 20 and 21, in the load balanced type switching apparatus (New) of the present invention, when the traffic load has 70% or more, an average delay amount is known to be small, as compared with the example 1 (Basic) and the example 2 (FOFF).

The allowable difference value in the load balanced type switching apparatus of the present invention is 1. In the load balanced type switching apparatus of the present invention, a small delay in the high load state is attained in cases that the numbers of the switch ports are 4 and 128. This reason is as follows. That is, in the load balanced type switching apparatus of the present invention, the input stage can transmit the cells without any waiting, as long as the deviation is not caused in the cells to be transmitted, and while the delay at the input stage is suppressed to the small value, the cells are uniformly distributed to the respective intermediate stages, and the delay for the waiting at the output stage can be reduced.

A second operation example of the load balanced type switching apparatus according to the first exemplary embodiment of the present invention will be described below. Here, an operation of the FOFF at the later stage will be described. In the second operation example, the operation of a transmitting cell selecting process is different in the first exemplary embodiment. In the second operation example, if the transmittable cell does not exist in the transmission counter as the result of the VOQ check, the VOQ buffer is again checked. If there are the M or more accumulation cells, in the M cell cycles therefrom, the cells are transmitted from the VOQ buffer of the specified same destination output stage. Since the output process is performed under the collection of the cells, the deviation does not occur in the number of the cells transmitted to any intermediate stage, as the result of the addition of this process.

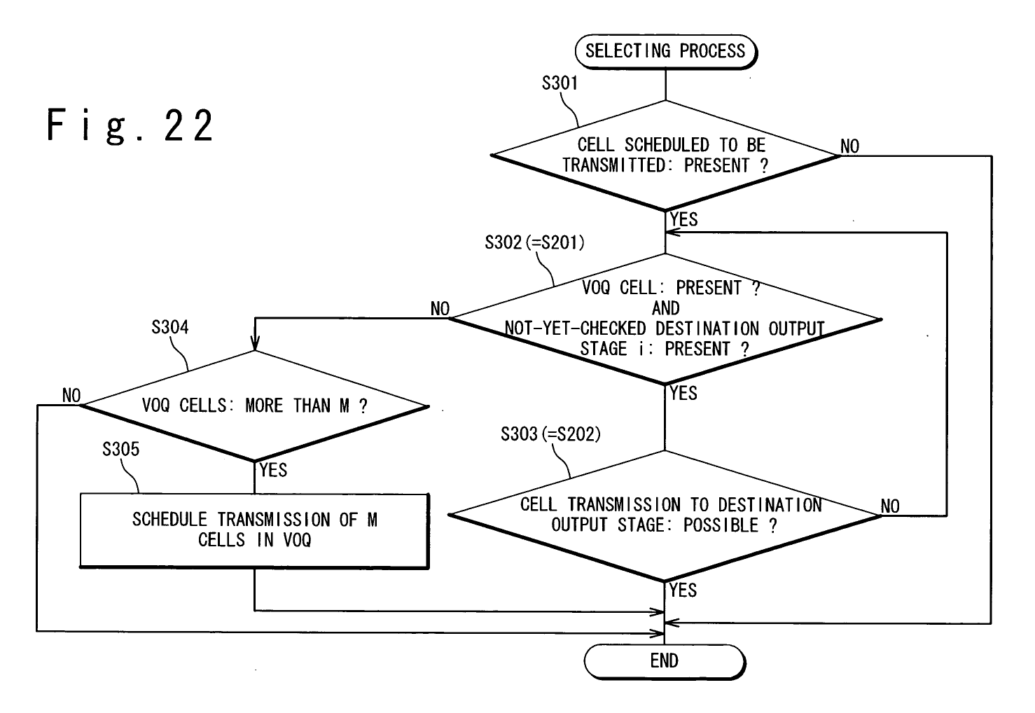

FIG. 22 shows an operation flowchart of the transmission cell selecting process in the second operation example.

### (1) Step S301

Whether or not the transmittable cell exists is determined. In the first exemplary embodiment, there is a case of the reservation that the plurality of cells are transmitted at the same time. Thus, in each cell time slot, when the cell is already in the reservation state, the transmission determination is not required.

### (2) Step S302

If the cell in the reservation state does not exist, whether or not there is a transmittable cell among the cells accumulated in the VOQ buffer is checked by using the transmission counter, similarly to the first exemplary embodiment of the present invention. At this time, the transmission cell determining section 23 checks whether or not there is cell having a certain destination output stage i and stored in the VOQ buffer, namely, whether or not there is the destination output stage in which voq_cnt[i]>0 and on which the check is not still performed. If there is not the foregoing output stage, the process is ended. This process is a same as the Step S201.

### (3) Step S303

If there is such an output stage, whether or not the cell having the destination output stage i can be transmitted by use of a cell time slot in the current intermediate stage is determined. If it can be transmitted, the corresponding cell is transmitted, and then the process is ended. If it cannot be transmitted, whether or not there is a different destination output stage is again checked. Then, until the transmittable cell is found out, or until any cell targeted for the check is reduced to 0, the process is repeated. This process is same as the Step S202.

### (4) Step S304

If there is not the transmittable cell, whether or not there is the destination output stage i in which the VOQ accumulation cell count voq_cnt[i] is equal to or greater than M that implies the number of the intermediate stages 2 is checked.

### (5) Step S305

If there is the destination output stage i in which the M or more cells are accumulated in the VOQ buffer, the transmission of the M cells is reserved. At the step S304, if there are the plurality of destination output stages in which the M or more cells are accumulated, which of the cells is used is considered by using a randomly selecting method, a round robin selecting method, and a method of selecting the destination output stage having the greatest one in the number of the accumulated cells.

In the second operation example, even in the cell time slot in which it cannot be transmitted in the first exemplary embodiment, if the N or more cells are accumulated in the VOQ buffer associated with a certain output stage, the cells can be transmitted. Thus, the effect of the reduction in the delay time at the input stage of that part can be attained.

The second operation example of the load balanced type switching apparatus of the present invention will be described below. Here, the former stage FOFF operation will be described.

In the second operation example, whether or not there is the destination output stage i in which the VOQ accumulation cell number is M or more is checked (S302). In case of the existence, a process of reserving the transmission of the M cells (S303) is performed prior to the transmission determining processes (S304 and S305) that use the transmission cell counter.

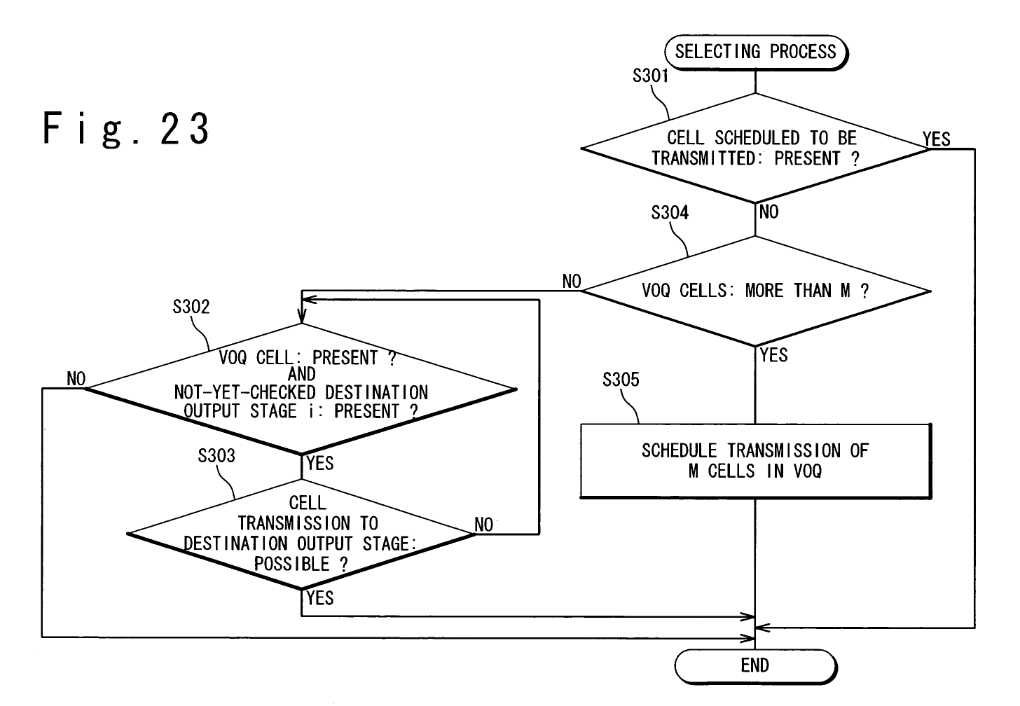

FIG. 23 shows an operation flowchart of the transmission cell selecting process in the second operation example.

### (1) Step S301

Whether or not there is the transmittable cell is determined. In each cell time slot, when the cell is already in the reservation state, the transmission determination is not required.

### (2) Step S304

If there is not the transmittable cell, whether or not there is the destination output stage i in which the VOQ accumulation cell count voq_cnt[i] is equal to or greater than M that implies the number of the intermediate stages 2 is checked.

### (3) Step S305

If there is the destination output stage i in which the M or more cells are accumulated in the VOQ buffer, the transmission of the M cells is reserved.

### (4) Step S302

If there is not any cell in the reservation state, similarly to the first exemplary embodiment, whether or not there is any transmittable cell of the cells accumulated in the VOQ buffer is checked by using the transmission counter. At this time, the transmission cell determining section 23 checks whether or not there is the VOQ accumulation cell having the destination output stage i, namely, whether or not there is the destination output stage in which voq_cnt[i]>0 and on which the check is not still performed. If there is not such an output stage, the process is ended.

### (5) Step S303

If there is such an output stage, whether or not the cell having the destination output stage i can be transmitted in the current intermediate stage cell time slot is determined. If it can be transmitted, the corresponding cell is transmitted, and then the process is ended. If it cannot be transmitted, whether or not there is a different destination output stage is again checked. Then, until the transmittable cell is found out, or until the cell targeted for the check is reduced to 0, the process is repeated.

The M or more accumulated cells are outputted with priority. Thus, the larger number of accumulated cells are transmitted with priority, and the effect of the reduction in the longest delay time can be attained.

Next, the load balanced type switching apparatus according to a third exemplary embodiment of the present invention will be described below. Here, a counter resetting operation will be described. In the third exemplary embodiment, under the condition that a cell is not received (or transmitted) in a certain period, the counter values (out_cnt, maximum value max_cnt and minimum value min_cnt) are reset. Under the condition that the cell is not received in the certain period, the transmitted cell is assumed to already arrive at the output stage 3 through the intermediate stage 2. Thus, even if a variation occurs in the transmission counter for each intermediate stage associated with a certain destination output stage, the cell does not actually exist in the intermediate stage. Thus, it is assumed that any deviation does not exist in the accumulation cell number. Therefore, the values in the respective counters that are in the deviated states are reset, which leads to the situation that there is no deviation.

It should be noted that as the reset control of the counter, a method is considered of performing it on the whole irrespectively of the destination output stage. However, a method is considered of performing the reset control only on the destination output stage that does not receive (or transmit) a cell in a certain period, for each destination output stage.

Since the counter of the output stage that does not receive (or transmit) any cell in the certain period is reset, the situation that the counter value is still in the deviated state is prevented, which can reduce the possibility that the cell cannot be transmitted due to the deviation of the counter. Thus, the effect of the reduction in the delay time at the input stage can be obtained.

The load balanced type switching apparatus according to a fourth exemplary embodiment of the present invention will be described below. Here, the counter resetting operation will be described.

In the fourth exemplary embodiment, an empty cell (a cell data that actually has no content) is inserted into the cell time slot in which the transmitting of the cell is not performed. The meaning of inserting the empty cell is to relax a deviation with regard to the destination output stage in which the deviation has occurred. For this purpose, the empty cell should not be unnecessarily inserted. For example, there is a case that a difference between the maximum transmission count and the minimum transmission count is within the allowable difference value, and the number of the intermediate stages in the minimum transmission count is K/4 or less, and the intermediate stage j under the transmission schedule is in the minimum transmission count. These conditions are represented by the following equation.

min_cnt[i]−max_cnt[i]==Differential Allowable Value &&

num_cnt[i][min_cnt[i]]<K/4 &&

out_cnt[i][j]==min_cnt[i]

It should be noted that with regard to the insertion of the empty cell, two kinds of the method that an empty cell is actually inserted and the method that the counter is updated under an assumption that the empty cell is imaginarily inserted are considered.

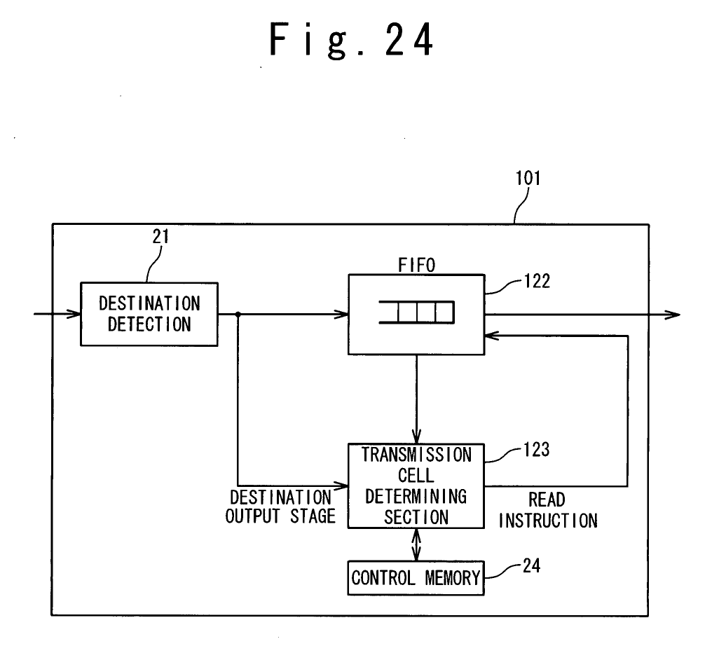

The second exemplary embodiment of the present invention will be described below. FIG. 24 shows the configuration of an input stage 101 of the load balanced type switching apparatus in the second exemplary apparatus embodiment of the present invention.

The input stage 101 is provided with a destination detecting section 21, an FIFO unit 122, a transmission cell determining section 123 and a control memory 24. The destination detecting section and the control memory are the same as those of the input stage 1 in FIG. 12. However, the VOQ unit 22 is replaced with the FIFO unit 122.

The FIFO unit 122 has only a single queue and transmits cells in an order of reception of reception cells. Also, the FIFO unit 122 notifies the data of the destination output stage of the head cell accumulated in the head of the queue to the transmission cell determining section 123.

The transmission cell determining section 123 is the same as the transmission cell determining section 23 in the first exemplary embodiment of the present invention, except that this determines the transmission of only the head cell of the FIFO unit 122 and notifies to the FIFO unit, whether or not it can be transmitted.

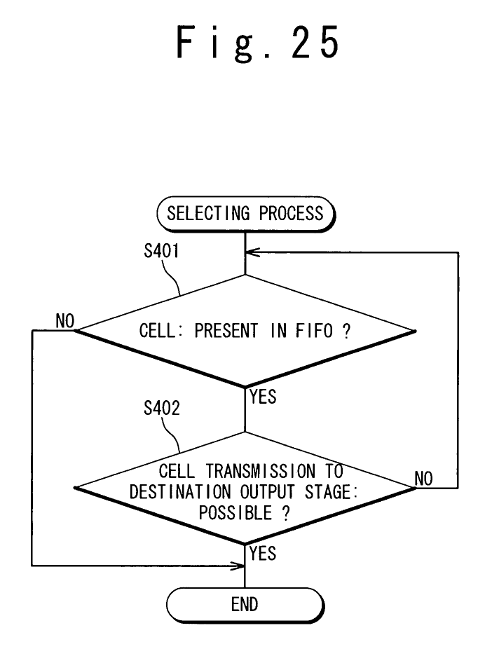

FIG. 25 is a flowchart showing a transmission cell selecting process by the transmission cell determining section 123.

### (1) Step S401

The transmission cell determining section 123 checks whether or not the cell is accumulated in a FIFO in the FIFO unit 122. If the cell is not accumulated in the FIFO, there is no cell targeted for the process. Thus, the process is ended.

### (2) Step S402

If the cell is accumulated in the FIFO, whether or not the cell having the destination output stage i can be transmitted is determined. The process content is identical to that of the S202. If the cell can be transmitted, the cell transmission is requested. However, if it cannot be transmitted, the cell transmission is not requested, and the process is ended.

In the second exemplary embodiment of the present invention, instead of the VOQ unit 22, the FIFO unit 122 is used to simplify the circuit. Also, only one cell per cell time slot is always determined. Therefore, the cell transmission can be determined within the fixed time irrespectively of the number of the ports.

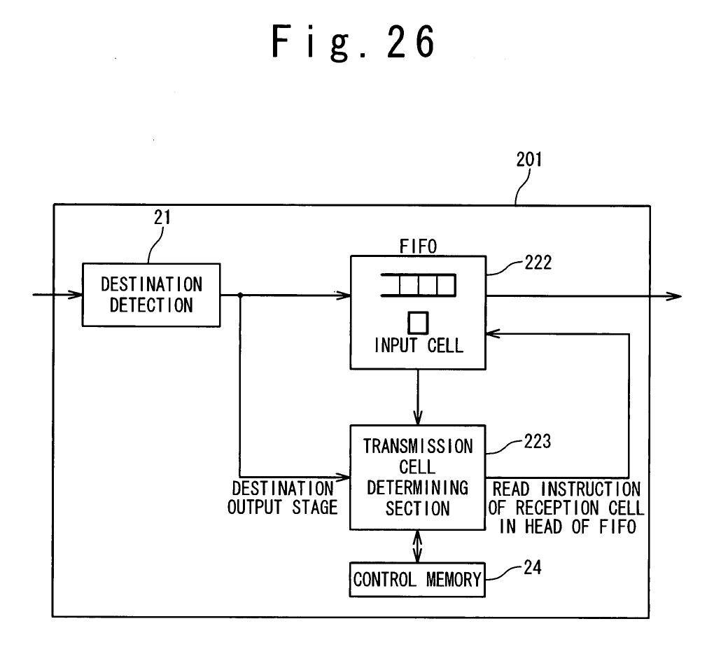

The third exemplary embodiment of the present invention will be described below. FIG. 26 shows the configuration of an input stage 201 of a load balanced type switching apparatus according to the third exemplary embodiment of the present invention.

The input stage 201 is provided with the destination detecting section 21, an FIFO unit 222, a transmission cell determining section 223 and the control memory 24. The destination detecting section and the control memory are the same as those of the input stage 1 in FIG. 12. However, the VOQ unit 22 is replaced with the FIFO unit 222.

The FIFO unit 222 separately manages a single waiting FIFO to accumulate a cell that cannot have been transmitted when it is received; and the cell immediately after the reception. The transmission cell determining section 223 can select and read the head cell in the FIFO and the cell immediately after the reception.

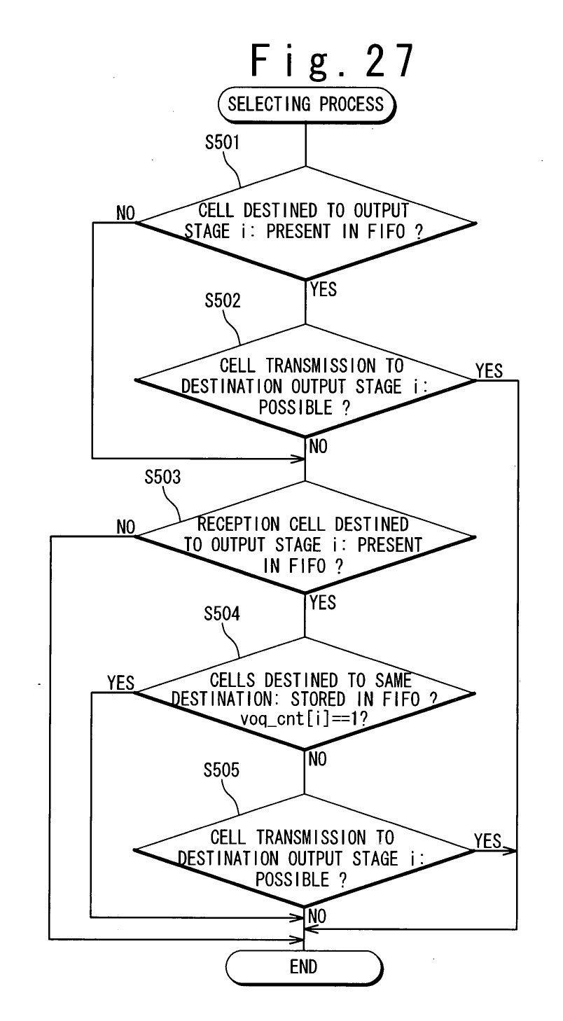

FIG. 27 is a flowchart showing the transmission cell selecting process by the transmission cell determining section 223.

### (1) Step S501

The transmission cell determining section firstly checks whether or not the cell is accumulated in the FIFO.

### (2) Step S502

If it is accumulated, whether or not the head cell can be transmitted is checked. The process content is identical to that of the step S2-2.

### (3) Step S503

If it can be transmitted, a transmission request of the head cell is issued, and the process is ended. If the transmission has not been done, whether or not there is the cell immediately after the reception is checked.

### (4) Step S504

If there is the cell immediately after the reception, whether or not the cell in the same destination output stage exists in the FIFO is checked.

### (5) Step S505

If there is no cell immediately after the reception, the process for determining whether or not the corresponding cell can be transmitted is performed. The process content is identical to that of the step S2-2. If the transmission is determined to be possible, the process of transmitting the reception cell is performed.

In the third exemplary embodiment of the present invention, similarly to the second exemplary embodiment of the present invention, instead of the VOQ unit 22, the FIFO unit 122 is used. Accordingly, the circuit configuration is simplified. Also, the transmission of the cell is determined two times per cell time slot at maximum. Thus, irrespectively of the number of the ports, the transmission of the cell can be determined within a predetermined time.

It should be noted that the mesh connection section 4 between the input stages 1 and the intermediate stages 2 shown in FIG. 5 can be designed to have the functions of the VOQ unit 22 and the FIFO unit 122. In this case, the mesh connection section 4 can be considered to be a part of the input stage 1. One feature of the present invention is in a process for distributing cells that are transmitted from the input stages to the intermediate stages. Thus, all of the devices, circuits and lines that are provided between the input stages and the intermediate stages can be considered to be a part of the input stages. Also, similarly, the mesh connection section 7 in FIG. 6 can be designed to have the functions of the VOQ unit 22 and the FIFO unit 122, of input stage functions of the line card 6.

Finally, features of the load balanced type switching apparatus of the present invention will be described below in detail.

The load balanced type switching apparatus of the present invention is provided with L input stages, M intermediate stages, N output stages, a mesh connection section for connecting the respective input stages and intermediate stages in the mesh manner; and a mesh connection section for connecting the respective intermediate stages and output stages in the mesh manner. In a process for distributing reception cells to the respective intermediate stages, the input stage performs the process of distributing cells so as to manage the transmission counter value out_cnt[i] [j] for each intermediate stage j and each destination output stage i so that for each destination output stage, the number of the cells transmitted to each intermediate stage falls in the certain range.

In the transmission cell determining section in each input stage, in a process of determining whether or not the cell destined to the destination output stage i can be transmitted to the intermediate stage j, this manages the maximum value max_cnt[i] and the minimum value min_cnt[i] in the transmission counter to each intermediate stage for each destination output stage i, and determines the cell to be transmittable if the difference between the maximum value and the minimum value is a value smaller than an allowable difference value or if the value of the transmission counter out_cnt[i][j] to the intermediate stage j does not become the maximum value max_cnt[i].

With regard to the respective parameters max_cnt, min_cnt and out_cnt, the value of K which exhibits K>the allowable difference value is used to manage them as the values (the remainders when the respective parameters are divided by K) after the module K calculation.

For each destination output stage i, the distribution of the count value (out_cnt[i][j]) to each intermediate stage j after module K calculation is managed in the counter distribution cnt_num [i][ ].

In the process of updating min_cnt[i], when the number of the intermediate stages having the minimum value min_cnt[i] is 1 (=cnt_num [i][min_cnt[i]]==1) and the transmission counter to the intermediate stage j for sending the cell coincides with min_cnt[i], min_cnt[i] is updated.

In the input stage, this is provided with the destination detecting unit, the VOQ unit, the transmission cell determining section and the control memory, and the transmission cell determining section selects one transmittable cell from the cells accumulated in the VOQ unit.

The input stage is provided with the destination detecting unit, a FIFO unit, the transmission cell determining section and the control memory, and the transmission cell determining section determines whether or not the cell accumulated in the head of the FIFO unit can be transmitted.

The input stage is provided with the destination detecting unit, the FIFO unit, the transmission cell determining section and the control memory. The FIFO unit has a function of accumulating the cell, which cannot be transmitted at the time of the reception, in the FIFO unit and separately manages the cells immediately after the reception. The transmission cell determining section has a function of specifying and reading the head cell in the FIFO unit or the cell immediately after the reception. Also, the transmission cell determining section determines whether or not the head cell in the FIFO unit can be transmitted, transmits the head cell in the FIFO unit if it can be transmitted, and determines whether or not the reception cell can be transmitted, if it cannot be transmitted.

The transmission reservation of a plurality of cell time slots can be performed in one cell time slot. When the cell is transmitted to a certain destination output stage i and when there are the plurality of cells accumulated in the VOQ buffer, the plurality of cells are continuously transmitted to the same destination output stage i. With regard to the destination output stage i for the transmission check, when there are the plurality of cells in the VOQ buffer and when the difference between the maximum value and the minimum value (max_cnt[i]−min_cnt[i]) is smaller than a allowable difference value, the transmission reservation is continuously performed on the plurality of cell time slots.

A process of selecting a transmittable cell from the cells accumulated in the VOQ buffer checks the destination output stages i in a random order. The process of selecting the transmittable cell from the cells accumulated in the VOQ buffer may check the destination output stages i in the order of a round robin method. In addition, the process of selecting the transmittable cell from the cells accumulated in the VOQ buffer checks the destination output stage of the cells in the VOQ buffer with higher priorities than the destination output stage of the cells immediately after the reception.

When the transmittable cell does not exist from the transmission counter value and when the destination output stage, in which the cells equal to or greater than K implying the number of the intermediate stages are accumulated, exists in the VOQ unit, the K cells in the output stage are continuously transmitted. Also, when the destination output stage, in which the cells equal to or more than K implying the number of the intermediate stages are accumulated, exists in the VOQ unit, the K cells in the destination output stage are continuously transmitted, and only when such a cell does not exist, the process of distributing the cells is performed in accordance with the transmission counter value.

A process of selecting a transmittable cell from the cells accumulated in the VOQ buffer, uses the list targeted for the check and sequentially checks from the head of the list. Also, only the destination output stage in which the cell is accumulated in the VOQ buffer is included in the list.

When the destination output stage of the cell to be transmitted is determined, the destination output stage is once removed from the list and if the cell remains in the VOQ unit, it is re-added to the tail of the list. Also, the possession of the priority parameter to determine an order of the list of the check target.

As the priority parameter, the number of the cells accumulated in the VOQ unit is used to preferentially check the cell in the destination output stage having the great number of the cells accumulated in the VOQ. Also, as the priority parameter, the difference between the maximum value and the minimum value (max_cnt[i]−max_cnt[i]) is used to preferentially check the cell in the destination output stage having the high priority parameter.

Although as the priority parameter, the cell in the destination output stage having the great difference (max_cnt[i]−max_cnt[i]) between the maximum value and the minimum count is used with a priority level, if the difference between the maximum count and the minimum count (max_cnt[i]−max_cnt[i]) is equal to each other, the cell in the destination output stage which has the small number (=cnt_num [i][min_cnt[i]] of the intermediate stages that is the minimum count value is checked with priority.

When the cell is transmitted to the intermediate stage j as the priority parameter, the cell in the destination output stage in which max_cnt[i]−out_cnt[i][j] is great is checked with priority. Also, when the cell is transmitted to the intermediate stage j as the priority parameter, the cell in the destination output stage in which the difference is great is checked with priority, and if the differences are equal to each other, the cell in the destination output stage having the small number of the intermediate stages, in which the count value is smaller than out_cnt[i][j] (j′ is out_cnt[i][j]>out_cnt[i][j′]) is checked with priority.

A process of each cell time slot in an updating process of the check target list updates only the check order of the received or transmitted cells in the destination output stage i. Also, a process of each cell time slot in the updating process of the check target list rearranges the check target list for each cell time slot.

The possession of a function of resetting the transmission counters, when the cell is not received in the certain period. The possession of the function of monitoring the reception interval of the cells for each destination output stage and resetting the value of the transmission counter in the destination output stage, when the cell is not received in the certain period. Moreover, the possession of a function of resetting the transmission counter values, when the cell is not transmitted during a certain period. The possession of a function of monitoring a transmission interval of the cells for each destination output stage and resetting the transmission counter value in the destination output stage, when the cell is not transmitted in the certain period.

If as the result of the determination using the transmission counter, there is no cell targeted for the transmission, the counter value is updated under the assumption that the cell is imaginarily transmitted to a certain destination output stage. Also, the process, which updates the counter value under the assumption that the cell is imaginarily transmitted, transmits the empty cell whose content is invalid.

As mentioned above, in the present invention, the input stage counts the number of cells, which are transmitted to the respective intermediate stages, for each output stage, and carries out the control so that the difference between the intermediate stages satisfies the allowable difference value. If the difference does not exceed the allowable difference value, the received cell is immediately transmitted to the intermediate stage. Thus, it is possible to attain the uniformly dispersing process for the intermediate stages, while reducing the delay at the input stage.

Each of the input stages in the load balanced type switching apparatus counts the number of the cells transmitted to each intermediate stage for each destination output stage, and carries out a control so that the number of the cells transmitted to each intermediate stage for each destination output stage falls within a certain range, and uniformly disperses the cells.

Each of the input stages can send the cells to the intermediate stages at the delay of 0, without any waiting for the received cells, in the situation that the number of the cells transmitted to each intermediate stage falls within the certain range. Thus, the number of the intermediate stages to which the cells can be transmitted is not limited to one location. Hence, while the delay at the input stage is reduced, the uniform dispersion to the intermediate stages can be attained.

Although the present invention has been described above in connection with several exemplary embodiments thereof, it will be apparent by those skilled in the art that those exemplary embodiments are provided solely for illustrating the present invention, and should not be relied upon to construe the appended claims in a limiting sense.

What is claimed is:

1. A load balanced type switching apparatus comprising input stages, intermediate stages connected with said input stages in a mesh manner, and output stages connected with said intermediate stages in a mesh manner,
wherein one of said input stages comprises:
a destination detecting section configured to detect a destination one of said output stages corresponding to a reception cell;
a cell transmitting section having a storage unit and connected with said intermediate stages in the mesh manner, and configured to store said reception cell from said destination detecting section in said storage unit based on said destination output stage of said reception cell; and
a transmission cell determining section configured to manage said cells stored in said storage unit for each destination output stage by using a transmission counter for every output stage and for every intermediate stage, and to select a transmittable cell from among said cells stored in said storage unit, such that a number of said cells to be transmitted to each of said intermediate stages falls within a predetermined range for every destination output stage,
wherein said cell transmitting section transmits said transmittable cell to one of said intermediate stages based on the management result.

2. The load balanced type switching apparatus according to claim 1, wherein said transmission cell determining section manages a maximum value max_cnt[i] and a minimum value min_cnt[i] of said transmission counter out_cnt[i][j] with respect to transmission of said cell of said destination output stage i to said intermediate stage j, checks whether or not a difference between the maximum value and the minimum value is within an allowable difference value or whether a value of said transmission counter is equal to said difference, and determines that said cell is transmittable when said difference between the maximum value and the minimum value is within said allowable difference value or the value of said transmission counter is not equal to said difference.

3. The load balanced type switching apparatus according to claim 2, wherein said transmission cell determining section manages a value as a result of a modulo K calculation on each of the maximum value, the minimum value and the transmission counter, by using K meeting K>said allowable difference value (K is an integer).

4. The load balanced type switching apparatus according to claim 3, wherein said transmission cell determining section manages a distribution of said transmission counter values obtained from the modulo K calculation to said intermediate stages for every destination output stage.

5. The load balanced type switching apparatus according to claim 4, wherein said transmission cell determining section performs a process of updating the minimum value, when a number of said intermediate stages having the minimum value is “1” and said transmission counter value to the intermediate stage j is coincident with the minimum value.

6. The load balanced type switching apparatus according to claim 1, wherein said storage unit comprises a VOQ (Virtual Output Queue) buffer for every destination output stage, and
said cell transmitting section stores said reception cell from said destination detecting section in said VOQ buffer for the destination output stage f said reception cell, and
said transmission cell determining section selects the transmittable one from among the cells stored in the VOQ buffer.

7. The load balanced type switching apparatus according to claim 6, wherein when a plurality of cells are stored in said VOQ buffer, said transmission cell determining section performs transmission reservation for continuous transmission of the plurality of cells to said destination output stage.

8. The load balanced type switching apparatus according to claim 6, wherein said transmission cell determining section checks said VOQ buffers to determine the transmittable cells in a random order of the destination output stages.

9. The load balanced type switching apparatus according to claim 6, wherein said transmission cell determining section checks said VOQ buffers to determine the transmittable cells in a round robin order of the destination output stages.

10. The load balanced type switching apparatus according to claim 6, wherein said transmission cell determining section checks said destination output stage of the cell stored in said VOQ buffer prior to the destination output stage of the reception cell.

11. The load balanced type switching apparatus according to claim 6, wherein said transmission cell determining section reserves continuous transmission for a plurality of cell time slots when there are a plurality of said cells destined to the destination output stage i in said VOQ buffer and said difference falls within said allowable difference value.

12. The load balanced type switching apparatus according to claim 6, wherein when it is determined from said transmission counter that there is no transmittable cell and when there is one VOQ buffer in which the cells are stored more than a number K of said intermediate stages, said transmission cell determining section continuously transmits K cells of the stored cells.

13. The load balanced type switching apparatus according to claim 6, wherein when there is one VOQ buffer in which the cells are stored more than a number K of said intermediate stages, said transmission cell determining section continuously transmits K cells of the stored cells, and
when there is no VOQ buffer in which the cells are stored more than a number K of said intermediate stages, said transmission cell determining section distributes the stored cells to said intermediate stages based on said transmission counter.

14. The load balanced type switching apparatus according to claim 6, wherein said transmission cell determining section checks said VOQ buffers sequentially from a head of a check target list to determine the transmittable cell, removes the VOQ buffer for the transmittable cell from the check target list once, and adds the VOQ buffer to an end of the check target list when there is remained any cell in the removed VOQ buffer.

15. The load balanced type switching apparatus according to claim 14, wherein said transmission cell determining section determines a check order of the check target list based on numbers of cells stored in the VOQ buffers as priority parameters for the VOQ buffers.

16. The load balanced type switching apparatus according to claim 14, wherein said transmission cell determining section determines a check order of the check target list based on said differences in the VOQ buffers as priority parameters.

17. The load balanced type switching apparatus according to claim 16, wherein said transmission cell determining section checks the VOQ buffer with priority when said differences are equal to each other and a number of said intermediate stages is smaller for the VOQ buffer.

18. The load balanced type switching apparatus according to claim 14, wherein said transmission cell determining section checks the VOQ buffer having a greater value of a difference between the maximum value and the transmission counter value with priority.

19. The load balanced type switching apparatus according to claim 18, wherein when the differences between the maximum value and the transmission counter value are equal to each other, said transmission cell determining section checks the VOQ buffer for a smaller transmission counter value with respect to said intermediate stages with priority.

20. The load balanced type switching apparatus according to claim 14, wherein said transmission cell determining section updates the check order of the VOQ buffer, from which the cell is transmitted, in a process of updating the check target list.

21. The load balanced type switching apparatus according to claim 14, wherein said transmission cell determining section rearranges the VOQ buffers of the check target list for each of a plurality of cell time slots in a process of updating the check target list.

22. The load balanced type switching apparatus according to claim 1, wherein said cell transmitting section stores a reception cell which have been not transmitted on reception, in a FIFO,
said transmission cell determining section checks whether a head cell in the FIFO is transmittable, transmits the head cell when the head cell is transmittable, and checks whether a reception cell is transmittable when the head cell is not transmittable.

23. The load balanced type switching apparatus according to claim 1, wherein said transmission cell determining section monitors a transmission interval for every destination output stage, and resets the transmission counter for the destination output stage when any cell is transmitted during a predetermined period.

24. The load balanced type switching apparatus according to claim 1, wherein when there is no cell to be transmitted as a result of determination in which the transmission counter is used, said transmission cell determining section updates the transmission counter by assuming transmission of a cell to the destination output stage.

25. The load balanced type switching apparatus according to claim 24, wherein said transmission cell determining section transmits an empty cell having no content in case of updating the transmission counter.

26. A switching method in a load balanced type switching apparatus comprising input stages, intermediate stages connected with said input stages in a mesh manner, and output stages connected with said intermediate stages in a mesh manner, said switching method comprising:
detecting a destination one of said output stages corresponding to a reception cell;
storing said reception cell in a storage unit based on said destination output stage of said reception cell;
determining a transmittable cell from among said cells stored in said storage unit for each destination output stage by using a transmission counter for every output stage and for every intermediate stage such that a number of said cells to be transmitted to each of said intermediate stages falls within a predetermined range for every destination output stage; and
transmitting said transmittable cell to one of said intermediate stages based on the management result.

27. The switching method according to claim 26, wherein said determining comprises:
managing a maximum value max_cnt[i] and a minimum value min_cnt[i] of said transmission counter out_cnt[i][j] with respect to transmission of said cell of said destination output stage i to said intermediate stage j;
checking whether or not a difference between the maximum value and the minimum value is within an allowable difference value or whether a value of said transmission counter is equal to said difference; and
determining that said cell is transmittable when said difference between the maximum value and the minimum value is within said allowable difference value or the value of said transmission counter is not equal to said difference.

28. The switching method according to claim 27, wherein said determining comprises:
managing a value as a result of a modulo K calculation on each of the maximum value, the minimum value and the transmission counter, by using K satisfying K>said allowable difference value (K is an integer).

29. The switching method according to claim 28, wherein said determining comprises:
managing a distribution of said transmission counter values obtained from the modulo K calculation to said intermediate stages for every destination output stage.

30. The switching method according to claim 29, wherein said determining comprises:
performing a process of updating the minimum value, when a number of said intermediate stages having the minimum value is “1” and said transmission counter value to the intermediate stage j is coincident with the minimum value.

31. The switching method according to claim 26, wherein said storage unit comprises a VOQ (Virtual Output Queue) buffer for every destination output stage, and
said determining comprises:
selecting the transmittable one from among the cells stored in the VOQ buffer.

32. The switching method according to claim 31, wherein said determining comprises:
when a plurality of cells are stored in said VOQ buffer, performing transmission reservation for continuous transmission of the plurality of cells to said destination output stage.

33. The switching method according to claim 31, wherein said determining comprises:
checking said VOQ buffers to determine the transmittable cells in a random order of the destination output stages.

34. The switching method according to claim 31, wherein said determining comprises:
checking said VOQ buffers to determine the transmittable cells in a round robin order of the destination output stages.

35. The switching method according to claim 31, wherein said determining comprises:
checking said destination output stage of the cell stored in said VOQ buffer prior to the destination output stage of the reception cell.

36. The switching method according to claim 31, wherein said determining comprises:
reserving continuous transmission for a plurality of cell time slots when there are a plurality of said cells destined to the destination output stage i in said VOQ buffer and said difference falls within said allowable difference value.

37. The switching method according to claim 31, wherein said determining comprises:
when it is determined from said transmission counter that there is no transmittable cell and when there is one VOQ buffer in which the cells are stored more than a number K of said intermediate stages, determining K cells of the stored cells to be transmittable, and
said transmitting comprises:
continuously transmitting the K cells.

38. The switching method according to claim 31, wherein said determining comprises:
when there is one VOQ buffer in which the cells are stored more than a number K of said intermediate stages, continuously transmitting K cells of the stored cells; and
when there is no VOQ buffer in which the cells are stored more than a number K of said intermediate stages, determining the stored cells to said intermediate stages to be transmittable based on said transmission counter.

39. The switching method according to claim 31, wherein said determining comprises:
checking said VOQ buffers sequentially from a head of a check target list to determine the transmittable cell;
removing the VOQ buffer for the transmittable cell from the check target list once; and
adding the removed VOQ buffer to an end of the check target list when there is remained any cell in the removed VOQ buffer.

40. The switching method according to claim 39, wherein said determining comprises:
determining a check order of the check target list based on numbers of cells stored in the VOQ buffers as priority parameters for the VOQ buffers.

41. The switching method according to claim 39, wherein said determining comprises:
determining a check order of the check target list based on said differences in the VOQ buffers as priority parameters.

42. The switching method according to claim 41, wherein said determining comprises:
checking the VOQ buffer with priority when said differences are equal to each other and a number of said intermediate stages is smaller for the VOQ buffer.

43. The switching method according to claim 39, wherein said determining comprises:
checking the VOQ buffer having a greater value of a difference between the maximum value and the transmission counter value with priority.

44. The switching method according to claim 43, wherein said determining comprises:
when the differences between the maximum value and the transmission counter value are equal to each other, checking the VOQ buffer for a smaller transmission counter value with respect to said intermediate stages with priority.

45. The switching method according to claim 39, wherein said determining comprises:
updating the check order of the VOQ buffer, from which the cell is transmitted, in a process of updating the check target list.

46. The switching method according to claim 39, wherein said determining comprises:
rearranging the VOQ buffers of the check target list for each of a plurality of cell time slots in a process of updating the check target list.

47. The switching method according to claim 26, wherein said storing comprises:
storing a reception cell which have been not transmitted on reception, in a FIFO,
said determining comprises:
checking whether a head cell in the FIFO is transmittable; and
checking whether a reception cell is transmittable when the head cell is not transmittable, and
said transmitting comprises:
transmitting the head cell when the head cell is transmittable.

48. The switching method according to claim 26, wherein said determining comprises:
monitoring a transmission interval for every destination output stage; and
resetting the transmission counter for the destination output stage when any cell is transmitted during a predetermined period.

49. The switching method according to claim 26, wherein said determining comprises:
when there is no cell to be transmitted as a result of determination in which the transmission counter is used, updating the transmission counter by assuming transmission of a cell to the destination output stage.

50. The switching method according to claim 49, wherein said transmitting comprises:
transmitting an empty cell having no content in case of updating the transmission counter.

51. A computer-readable software product for realizing a switching method in a load balanced type switching apparatus comprising input stages, intermediate stages connected with said input stages in a mesh manner, and output stages connected with said intermediate stages in a mesh manner,
wherein said switching method comprises:
detecting a destination one of said output stages corresponding to a reception cell;
storing said reception cell in a storage unit based on said destination output stage of said reception cell;
determining a transmittable cell from among said cells stored in said storage unit for each destination output stage by using a transmission counter for every output stage and for every intermediate stage such that a number of said cells to be transmitted to each of said intermediate stages falls within a predetermined range for every destination output stage; and
transmitting said transmittable cell to one of said intermediate stages based on the management result.
